(19) United States
(12) Patent Application Publication
(10) Pub. No.: US 2010/0178577 A1
(43) Pub. Date: Jul. 15, 2010

(54) FUEL CELL SYSTEM

(76) Inventors: Junji Morita, Kyoto (JP); Yasushi Sugawara, Osaka (JP); Soichi Shibata, Osaka (JP); Takayuki Urata, Hyogo (JP); Takahiro Umeda, Nara (JP)

Correspondence Address: MCDERMOTT WILL & EMERY LLP, 600 13TH STREET, NW, WASHINGTON, DC, 20005-3096, US

(21) Appl. No.: 12/376,688

(22) PCT Filed: Sep. 27, 2007
(86) PCT No.: PCT/JP2007/068830

§ 371 Date: Feb. 6, 2009

(30) Foreign Application Priority Data
Sep. 27, 2006 (JP) 2006-262664

(51) Int. Cl. H01M 8/04

(52) U.S. Cl. 429/434

(57) ABSTRACT

A fuel cell system (100) is disclosed, which has a fuel gas generator (3) configured to be supplied with raw fuel, water and fuel for combustion to generate fuel gas by utilizing the combustion heat of the fuel for combustion; a fuel cell (1) configured such that the fuel gas is supplied to fuel gas routes (b1, 1a, c1) and oxidizing gas is supplied, thereby generating electric power; heating medium routes (b2, 1d, c2) configured such that the fuel gas is supplied thereto instead of being supplied to the fuel gas routes; a route switching device (4) configured to switch the destination of the fuel gas between the fuel gas routes and the heating medium routes; and a controller (8). The controller controls the route switching device such that, during warming-up of the fuel gas generator, the fuel gas is supplied to the heating medium routes and then used as the fuel for combustion and such that, after the warming-up, the fuel gas is supplied to the fuel gas routes instead of being supplied to the heating medium routes and then used as the fuel for combustion.

### TECHNICAL FIELD

The present invention relates to a fuel cell system for performing power generating operation by use of fuel gas and oxidizing gas and more particularly to a fuel cell system that performs power generating operation according to the electric power demand of the load.

### BACKGROUND ART

Fuel cell cogeneration systems (hereinafter referred to as “fuel cell systems”), which have high power generation efficiency and total efficiency, have been drawing attention as a small-scale power generation system capable of making effective use of energy.

Fuel cell systems have a fuel cell stack as the main body of the power generation part thereof. As the fuel cell stack, any of molten carbonate fuel cell stacks, alkaline fuel cell stacks, phosphoric acid fuel cell stacks, polymer electrolyte fuel cell stacks and others is used. Of these fuel cell stacks, phosphoric acid fuel cell stacks and polymer electrolyte fuel cell stacks perform power generating operation at lower temperatures compared to other fuel cell stacks and therefore often used as a fuel cell stack that constitutes a fuel cell system. Especially, polymer electrolyte fuel cell stacks exhibit high output density and remarkable long-term reliability and are therefore well suited for use in fuel cell systems.

The configuration and operation of a common fuel cell system having a polymer electrolyte fuel cell stack will be outlined below. In the following description, “fuel cell stack” will be called “fuel cell” and “polymer electrolyte fuel cell stack” will be called “polymer electrolyte fuel cell”.

First, the configuration of a polymer electrolyte fuel cell will be described.

The polymer electrolyte fuel cell has cells. A cell includes a membrane electrode assembly (MEA). The membrane electrode assembly has a polymer electrolyte membrane for selectively transporting hydrogen ions and a pair of gas diffusion electrodes that sandwich the polymer electrolyte membrane. A pair of gaskets are provided so as to surround the polymer electrolyte membrane in order to prevent leakage and mixing of the fuel gas and oxidizing gas. The membrane electrode assembly and the pair of gaskets are sandwiched between a pair of electrically-conductive separators. The electrically-conductive separator located on the anode side feeds the fuel cell to the membrane electrode assembly and has a fuel gas passage for discharging redundant fuel gas and steam. The electrically-conductive separator on the cathode side feeds the oxidizing gas to the membrane electrode assembly and has an oxidizing gas passage for discharging redundant oxidizing gas and water that is created as power generation proceeds.

This polymer electrolyte fuel cell includes several tens to several hundreds of cells and coolers for cooling these cells with a cooling medium fed to a cooling medium passage. Specifically, the cells and the coolers are alternately stacked or one cooler is stacked per several cells. The stack composed of the several tens to several hundreds of cells and the coolers is provided with an end plate at both ends thereof, each end plate being firmly fastened to the stack through a power collecting plate and an insulating plate by means of fastener rods. Cells of every adjacent pair are electrically connected to each other. Every cell and its adjacent cooler are electrically connected to each other. That is, in the polymer electrolyte fuel cell, several tens to several hundreds of cells are electrically connected in series through the coolers.

Next, the configuration of a fuel cell system having a polymer electrolyte fuel cell will be explained with reference to the drawings.

FIG. 8 is a block diagram that schematically shows the configuration of a prior art fuel cell system having a polymer electrolyte fuel cell.

As illustrated in FIG. 8, a known fuel cell system 200 has a polymer electrolyte fuel cell 101 serving as the main body of its power generation part and a temperature detector 102. When a hydrogen-contained fuel gas and an oxygen-contained oxidizing gas are fed to the fuel gas passage and the oxidizing gas passage respectively and a cooling medium is fed to the cooling medium passage, the polymer electrolyte fuel cell 101 generates electric power and heat by promoting an electrochemical reaction that uses hydrogen contained in the fuel gas and oxygen contained in the oxidizing gas. The temperature detector 102 detects the temperature of the polymer electrolyte fuel cell 101.

The fuel cell system 200 includes a fuel gas generator 103, a route switching device 104, a detour 109, a route switching device 105, an oxidizing gas feeder 106, a cooling medium circulation unit 107 and a controller 108. The fuel gas generator 103 generates the hydrogen-containing fuel gas, using water and raw fuel such as city gas. The route switching device 104 switches the destination of the fuel gas generated in the fuel gas generator 103 between the fuel gas passage of the polymer electrolyte fuel cell 101 and the detour 109. The route switching device 105 switches the feeding source of combustible gas to be fed to the combustor (not shown) of the fuel gas generator 103 between the fuel gas passage of the polymer electrolyte fuel cell 101 and the detour 109. The oxidizing gas feeder 106 introduces the oxidizing gas from the outside of the fuel cell system 200 to feed to the oxidizing gas passage of the polymer electrolyte fuel cell 101. The cooling medium circulation unit 107 circulates the cooling medium between the unit 107 and the cooling medium passage of the polymer electrolyte fuel cell 101. The controller 108 controls the components of the fuel cell system 200 respectively, thereby controlling the whole operation of the fuel cell system 200.

Next, the operation of the fuel cell system having the polymer electrolyte fuel cell will be described.

In the fuel cell system 200, the fuel gas generator 103 starts generation of the fuel gas when supplied with the raw fuel such as city gas and water. At the start of fuel gas generation, the fuel gas generated by the fuel gas generator 103 contains a high concentration of carbon monoxide. Therefore, the fuel gas generated in the fuel gas generator 103 is not fed to the polymer electrolyte fuel cell 101 but fed to the combustor (not shown) of the fuel gas generator 103 through the route switching device 104, the detour 109 and the route switching device 105.

After feeding of the fuel gas which has been reduced in carbon monoxide content becomes possible, the fuel gas generator 103 feeds the fuel gas to the fuel gas passage of the polymer electrolyte fuel cell 101 and the oxidizing gas feeder 106 feeds the oxidizing gas to the oxidizing gas passage. Then, an electrochemical reaction that uses hydrogen contained in the fuel gas and oxygen contained in the oxidizing gas proceeds in the membrane electrode assembly of the polymer electrolyte fuel cell 101. With this electrochemical reaction, the polymer electrolyte fuel cell 101 generates electric power and heat at the same time. At that time, the cooling medium passage of the coolers provided in the polymer electrolyte fuel cell 101 is supplied with the cooling medium. The cooling medium receives heat generated by the cells and carries the heat to the outside of the polymer electrolyte fuel cell 101. In this way, the electrochemical reaction using hydrogen and oxygen properly proceeds in the polymer electrolyte fuel cell 101.

Redundant fuel gas, which has not been used for the electrochemical reaction, is discharged from the polymer electrolyte fuel cell 101 together with redundant steam and supplied to the combustor (not shown) of the fuel gas generator 103. Redundant oxidizing gas, which has not been used for the electrochemical reaction, is discharged from the polymer electrolyte fuel cell 101 together with water generated during the power generation and then outwardly ejected from the fuel cell system 200 as waste. The cooling medium discharged from the polymer electrolyte fuel cell 101 is cooled by the cooling medium circulation unit 107 and then fed to the polymer electrolyte fuel cell 101 again.

Incidentally, fuel cell systems generally perform power generating operation and stand-by operation. In the power generating operation, the fuel cell is supplied with the fuel gas from the fuel gas generator and the oxidizing gas from the oxidizing gas feeder to generate electric power. During the stand-by operation, the power generation and other operations associated therewith are stopped. In the fuel cell systems, start-up operation and shut-down operation are performed in addition to the power generating operation and the stand-by operation. The start-up operation is for shifting the operational status of the fuel cell system from the stand-by operation to the power generating operation, whereas the shut-down operation is for shifting the operational status of the fuel cell system from the power generating operation to the stand-by operation. To avoid wasteful running costs, general fuel cell systems for household use usually perform DSS operation according to the electric power demand of the load, such that the power generating operation is not performed in time zones during which the power consumption of the load is low but performed in time zones during which the power consumption of the load is high.

In the DSS operation, the temperature of the fuel cell provided in the fuel cell system drops to a temperature approximately equal to the environmental temperature during the period of the stand-by operation. The electrochemical reaction associated with power generation properly progresses when the temperature of the fuel cell is within a specified range but makes virtually no progress when the temperature of the fuel cell is lower than a specified temperature. Herein, the fuel cell generates heat as power generation progresses during the power generating operation but generates no heat at all during the shut-down, stand-by and start-up operations. Therefore, the temperature of the fuel cell should be raised to a specified temperature suitable for the progress of the electrochemical reaction beforehand during the period of the start-up operation of the fuel cell system, in order to surely obtain desired electric power immediately after starting the power generating operation of the fuel cell system.

As an attempt to meet the above demand, there has been proposed a fuel cell system (see e.g., Patent Document 1) having a fuel cell that is constructed by stacking cells for generating electric power with hydrogen and water supplied thereto; heating medium layers for adjusting the temperature of the cells; and combustion layers for heating the heating medium layers. This fuel cell system is capable of raising the temperature of the fuel cell by use of heat generated by the catalytic combustion of hydrogen in the combustion layers.

There has been proposed another fuel cell system which is provided with a cooling water tank for storing cooling water and a heater for heating the cooling water, and in which the temperature of the fuel cell is raised by the cooling water supplied from the cooling water tank which cooling water has been raised in temperature, heated by the heater.

Another proposed fuel cell system is such that a heat exchanger and a combustor are provided and the temperature of the fuel cell is raised by supplying cooling water to the fuel cell, which cooling water has been raised in temperature, heated by the heat exchanger to which the combustion heat of combustible gas is supplied from the combustor.

Patent Document 1: JP-A-2004-319363

### DISCLOSURE OF THE INVENTION

### Problems that the Invention Intends to Solve

However, the previously proposed system, provided with the fuel cell having cells, heating medium layers and combustion layers, has the disadvantage that the provision of the heating medium layers and the combustion layers in addition to the cells makes the fuel cell complicated in configuration and large in size. As a result, the fuel cell system becomes complicated in configuration and large in size.

In addition, this known system presents the problem that the provision of the heating medium layers and the combustion layers causes an increase in the heat capacity of the fuel cell. Therefore, during the start-up operation of the fuel cell system, the temperature of the fuel cell cannot be surely raised to a specified temperature in some cases.

Another disadvantage of this known system is such that although the catalytic combustion of hydrogen proceeds in the combustion layers, the heat generation caused by this catalytic combustion is local heat generation and therefore the temperature of the heating medium layers cannot be uniformly and sufficiently raised in some cases. As a result, the temperature of the fuel cell cannot be uniformly and sufficiently raised throughout the entire area thereof in some cases.

Further, this previous proposal requires an additional operation, i.e., preheating of the fuel cell by use of hydrogen having a lot of energy utilizable for heating etc. and therefore has still room for improvement in terms of energy saving. This sometimes could be a disadvantage in properly constructing a fuel cell system capable of making effective use of energy.

In short, the previous proposal described above has difficulty in familiarizing a high-efficiency fuel cell system suited for the DSS operation among home consumers.

The previously proposed system, designed to heat cooling water with a heater, has revealed the problem that it requires electric power for driving the heater, so that the power generation efficiency of the fuel cell system decreases. This spoils the advantage of this fuel cell system. The previously proposed system, designed to heat cooling water with a combustor and a heat exchanger, also presents the problem that the speed of heating the cooling water sometimes fluctuates, under the influence of heat loses in the combustor and the heat exchanger as well as environmental temperature. This spoils the user-friendliness of this fuel cell system.

The invention is directed to overcoming the problems presented by the previous techniques and an object of the invention is therefore to provide a fuel cell system which has a simple, small-scale configuration and is capable of reliably raising the temperature of the fuel cell to a specified temperature suited for the progress of an electrochemical reaction without wasting energy during start-up operation to thereby surely obtain desired electric power immediately after start of power generating operation.

### Means of Solving the Problems

The inventors of the present application have focused attention to the following fact: Although the fuel cell systems designed to generate fuel gas through a chemical reaction employ configurations in which the combustion heat of the fuel gas containing a high concentration of carbon monoxide is utilized (e.g., configurations in which the fuel gas generated during the start-up operation of the fuel cell system is combusted for heating the catalyst used for the above chemical reaction), they are not configured to utilize the heat of such low-quality fuel gas itself.

In the wake of the recent technical improvement that has lowered the start-up temperature of polymer electrolyte fuel cells from about 50° C. to about 20° C., the inventors have made an intensive study of configurations that enable it to effectively preheat a polymer electrolyte fuel cell by making use of the heat (a small quantity of latent heat) of the low-quality fuel gas itself generated during the start-up operation of the fuel cell system.

As a result, the inventors have found a distinguishing configuration in which the heat of the low-quality fuel gas itself generated during the start-up operation is effectively used for raising the temperature of the fuel cell to a specified temperature suited for the progress of an electrochemical reaction during the start-up operation of the fuel cell system.

Specifically, the above existing problem can be overcome by a fuel cell system according to the invention, the system comprising:

a fuel gas generator configured to be supplied with raw fuel, water and fuel for combustion to generate hydrogen-containing fuel gas by making use of a combustion heat of the fuel for combustion;

a fuel cell configured such that the fuel gas generated in the fuel gas generator is supplied to a fuel gas route provided in the fuel cell and oxidizing gas is supplied to an oxidizing gas route provided in the fuel cell, whereby electric power is generated;

a heating medium route configured such that the fuel gas generated in the fuel gas generator is supplied thereto instead of being supplied to the fuel gas route and at least a part of the heating medium passage passes through the fuel cell;

a route switching device configured to switch a destination of the fuel gas generated in the fuel gas generator between the fuel gas route and the heating medium route; and

a controller,

wherein the controller is configured to control the route switching device such that, during warming-up of the fuel gas generator, the fuel gas generated in the fuel gas generator is supplied to the heating medium route and then supplied to the fuel gas generator as the fuel for combustion and such that, after warming up of the fuel gas generator, the fuel gas generated in the fuel gas generator is supplied to the fuel gas route instead of being supplied to the heating medium route and then supplied to the fuel gas generator as the fuel for combustion.

The above fuel cell system has a simple and small-scale configuration and is capable of reliably raising the temperature of the fuel cell to a specified temperature suitable for the progress of an electrochemical reaction without wasting energy during start-up operation, so that desired electric power can be surely obtained immediately after start of power generating operation.

The above construction makes it possible to change the destination of the fuel gas generated in the fuel generator in a moment in accordance with the start-up, power generation, shut-down and stand-by operations of the fuel cell system. In addition, there is no need to provide a plurality of pipes between the fuel gas generator and the fuel cell, which further simplifies the configuration of the fuel cell system.

In this case, the fuel cell system further comprises a cooling medium route configured to allow a cooling medium to flow therein and at least a part of the cooling medium route passes through the fuel cell. And, the at least part of the cooling medium route and at least a part of the heating medium route are close to each other.

The above construction enables heat exchange between the cooling medium flowing in the part of the cooling medium route and the fuel gas flowing as the heating medium in the part of the heating medium route. This enables not only heat transfer from the fuel gas serving as the heating medium to the fuel cell but also heat transfer from the fuel gas serving as the heating medium to the cooling medium, so that the temperature of the fuel cell can be effectively and uniformly raised.

In this case, the at least part of the cooling medium route has a cooling medium supply manifold whereas the at least part of the heating medium route has a heating medium penetration passage, and the cooling medium supply manifold and the heating medium penetration passage are arranged in parallel.

This construction enables more effective heat transfer from the fuel gas serving as the heating medium to the cooling medium so that the temperature of the fuel cell can be more effectively and uniformly increased.

In this case, a wall portion of the heating medium penetration passage has at least either a concave part or a convex part, and the cooling medium supply manifold and the heating medium penetration passage having at least either the concave part or the convex part are arranged in parallel.

This construction increases the heat exchange area of the heating medium penetration passage so that the temperature of the fuel cell can be more effectively increased.

In this case, the fuel cell includes a stack of cells each having a membrane electrode assembly composed of an electrolyte membrane and a pair of gas diffusion electrodes sandwiching the electrolyte membrane and a pair of electrically-conductive separators sandwiching the membrane electrode assembly. The cells have manifold holes configured to allow the cooling medium to pass therethrough to flow to the outside of the gas diffusion electrodes and through holes configured to allow the fuel gas to pass therethrough. The manifold holes are coupled in a stacking direction of the cells to form the cooling medium supply manifold and the through holes are coupled in the stacking direction to form the heating medium penetration passage.

In this construction, the fuel gas will not come into direct contact with the gas diffusion electrodes even if the fuel gas of high carbon monoxide content generated in the fuel gas generator is directly fed to the fuel cell during the start-up operation. Therefore, the temperature of the fuel cell can be surely raised without causing deterioration of the performance of the membrane electrode assembly.

In the above case, the at least part of the cooling medium route has a cooling medium supply manifold, a cooling medium passage connected to the cooling medium supply manifold and a cooling medium discharge manifold connected to the cooling medium passage. The at least part of the heating medium route has a heating medium supply manifold, a heating medium passage connected to the heating medium supply manifold and a heating medium discharge manifold connected to the heating medium passage. The cooling medium supply manifold and the heating medium supply manifold are arranged in parallel, the cooling medium passage and the heating medium passage are close to each other, and the cooling medium discharge manifold and the heating medium discharge manifold are arranged in parallel.

This construction enables more effective heat transfer from the fuel gas serving as the heating medium to the cooling medium so that the temperature of the fuel cell can be more effectively and uniformly raised.

In this case, the cooling medium passage and the heating medium passage have a serpentine shape, and the cooling medium passage and heating medium passage having the serpentine shape are arranged in parallel in a serpentine fashion.

This construction increases the heating medium passage length of the fuel cell so that the temperature of the fuel cell can be more effectively raised.

In this case, the heating medium passage includes a first heating medium passage and a second heating medium passage, and the cooling medium passage is enclosed by the first and second heating medium passages.

This construction also increases the heating medium passage length of the fuel cell so that the temperature of the fuel cell can be more effectively raised.

In the above case, the fuel cell includes a stack of cells each having a membrane electrode assembly composed of an electrolyte membrane and a pair of gas diffusion electrodes sandwiching the electrolyte membrane and a pair of electrically-conductive separators sandwiching the membrane electrode assembly. The cells have first manifold holes configured to allow the cooling medium to pass therethrough to flow to the outside of the gas diffusion electrodes, second manifold holes configured to allow the fuel gas to pass therethrough, third manifold holes configured to allow the cooling medium to pass therethrough and fourth manifold holes configured to allow the fuel gas to pass therethrough. The first manifold holes are coupled in a stacking direction of the cells to form the cooling medium supply manifold. The second manifold holes are coupled in the stacking direction to form the heating medium supply manifold. The third manifold holes are coupled in the stacking direction to form the cooling medium discharge manifold. The fourth manifold holes are coupled in the stacking direction to form the heating medium discharge manifold.

In this construction, the fuel gas will not come into direct contact with the gas diffusion electrodes even if the fuel gas of high carbon monoxide content generated in the fuel gas generator is directly fed to the fuel cell during the start-up operation. Therefore, the temperature of the fuel cell can be surely raised without causing deterioration of the performance of the membrane electrode assembly.

### EFFECTS OF THE INVENTION

The invention is implemented by the means described above and has the effect of providing a fuel cell system which has a simple, small-scale configuration and is capable of reliably raising the temperature of the fuel cell to a specified temperature suited for the progress of an electrochemical reaction without wasting energy during start-up operation to thereby surely obtain desired electric power immediately after start of power generating operation.

### BRIEF DESCRIPTION OF DRAWINGS

FIG. 1 is a block diagram that schematically shows a fuel cell system configuration according to first to fifth embodiments of the invention.

FIG. 2(a) is a perspective view that schematically shows an arrangement and configuration of a heating medium penetration passage, a cooling medium supply manifold, a cooling medium passage and a cooling medium discharge manifold in a polymer electrolyte fuel cell according to the first embodiment of the invention. FIG. 2(b) is an exploded perspective view that schematically shows an internal configuration of an cell provided in the polymer electrolyte fuel cell according to the first embodiment of the invention.

FIG. 3 is a flow chart that schematically shows a start-up operation of the fuel cell system according to the first embodiment of the invention.

FIG. 4(a) is a perspective view that schematically shows an arrangement and configuration of a heating medium supply manifold, a cooling medium supply manifold, a heating medium passage, a cooling medium passage, a heating medium discharge manifold and a cooling medium discharge manifold in a polymer electrolyte fuel cell according to the second embodiment of the invention. FIG. 4(b) is an exploded perspective view that schematically shows an internal configuration of an cell provided in the polymer electrolyte fuel cell according to the second embodiment of the invention.

FIG. 5(a) is a front view that schematically shows a first configuration of a heating medium penetration passage provided in a polymer electrolyte fuel cell according to the third embodiment of the invention. FIG. 5(b) is a sectional view that schematically shows a second configuration of the heating medium penetration passage provided in the polymer electrolyte fuel cell according to the third embodiment of the invention.

FIG. 6(a) is a perspective view that schematically shows an arrangement and configuration of a heating medium supply manifold, a cooling medium supply manifold, a heating medium passage, a cooling medium passage, a heating medium discharge manifold and a cooling medium discharge manifold in a polymer electrolyte fuel cell according to the fourth embodiment of the invention. FIG. 6(b) is an exploded perspective view that schematically shows an internal configuration of an cell provided in the polymer electrolyte fuel cell according to the fourth embodiment of the invention.

FIG. 7(a) is a perspective view that schematically shows an arrangement and configuration of heating medium supply manifolds, a cooling medium supply manifold, heating medium passages, a cooling medium passage, heating medium discharge manifolds and a cooling medium discharge manifold in a polymer electrolyte fuel cell according to the fifth embodiment of the invention. FIG. 7(b) is an exploded perspective view that schematically shows an internal configuration of an cell provided in the polymer electrolyte fuel cell according to the fifth embodiment of the invention.

FIG. 8 is a block diagram that schematically shows the configuration of a prior art fuel cell system having a polymer electrolyte fuel cell.

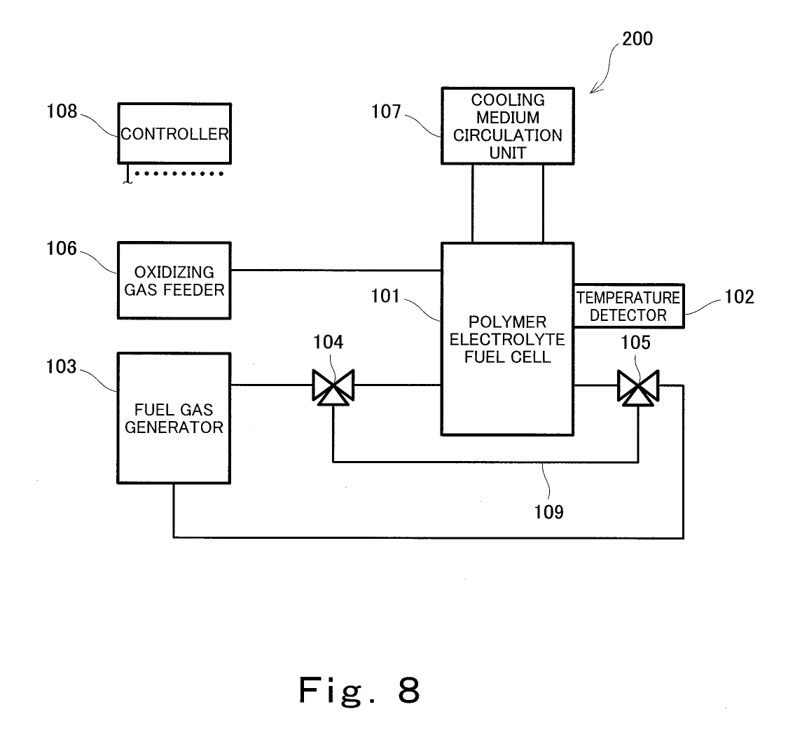

### REFERENCE NUMERALS IN THE DRAWINGS

1: polymer electrolyte fuel cell (fuel cell)
1a: part of fuel gas route
1b: part of oxidizing gas route
1c: part of cooling medium route
1d: part of heating medium route
2: temperature detector
3: fuel gas generator
4, 5: route switching device
6: oxidizing gas feeder
7: cooling medium circulation unit
8: controller
10: cells
10an electrically-conductive separator
10b: membrane electrode assembly
10c: electrically-conductive separator
11: cooling medium supply manifold
12: cooling medium discharge manifold
13a: heating medium penetration passage
13b, 13c: heating medium supply manifold
14: heating medium discharge manifold
14a, 14b: heating medium discharge manifold
101: polymer electrolyte fuel cell
102: temperature detector
103: fuel gas generator
104, 105: route switching device
106: oxidizing gas feeder
107: cooling medium circulation unit
108: controller
109: detour
100, 200: fuel cell system
a: pipe
b1, b2: pipe
c1, c2: pipe
d-h: pipe
Pf: fuel gas passage
Pm: heating medium passage
Pm1: first heating medium passage
Pm2: second heating medium passage
Po: oxidizing gas passage
Pw: cooling medium passage
Ha, Hb, Hc: through hole
Ha1, Ha2: manifold hole
Hb1, Hb2: manifold hole
Hc1, Hc2: manifold hole
Hd1, Hd2: manifold hole
He1, He2: manifold hole
Hf1, Hf2: manifold hole
Hwa1, Hwa2: manifold hole
Hwb1, Hwb2: manifold hole
Hwc1, Hwc2: manifold hole
Hoa1, Hoa2: manifold hole
Hob1, Hob2: manifold hole
Hoc1, Hoc2: manifold hole
Hfa1, Hfa2: manifold hole
Hfb1, Hfb2: manifold hole
Hfc1, Hfc2: manifold hole
E1, E2: gas diffusion electrode
M: polymer electrolyte membrane (electrolyte membrane)
S1, S2: seal

### BEST MODE FOR CARRYING OUT THE INVENTION

A structural feature of the fuel cell system of the invention resides in having a heating medium passage for flowing a fuel gas used as a heating medium, in addition to a fuel gas passage, oxidizing gas passage and cooling medium passage which are conventionally used.

An operational feature of the fuel cell system of the invention is that low-quality fuel gas flows from the fuel gas generator to the heating medium passage of the fuel cell system as a heating medium during start-up operation, thereby surely raising the temperature of the polymer electrolyte fuel cell to a specified temperature suited for the progress of an electrochemical reaction.

Referring now to the accompanying drawings, a best mode for carrying out the invention will be described in detail.

### First Embodiment

First, the configuration of a fuel cell system according to a first embodiment will be described in detail with reference to the drawings.

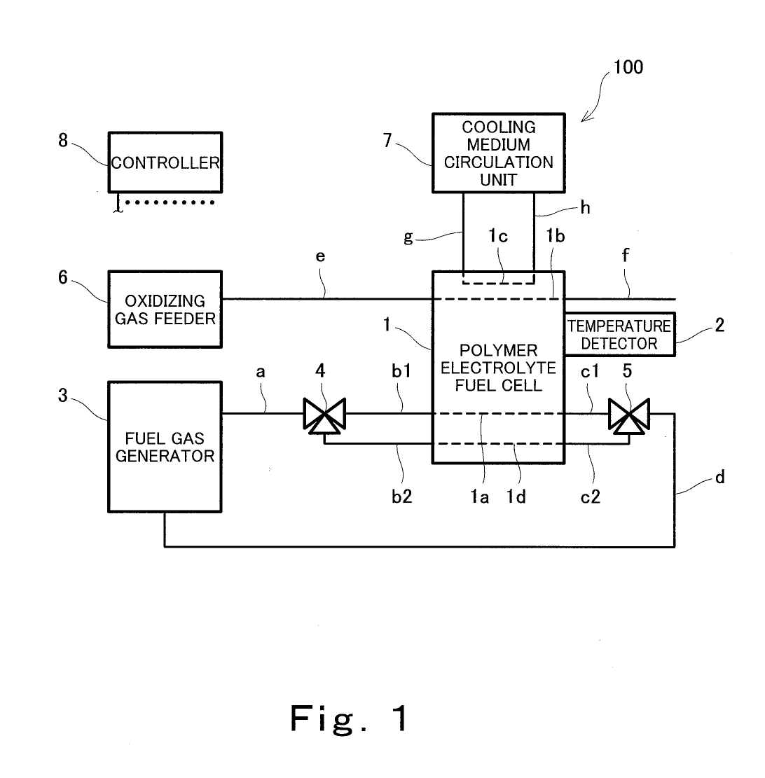

FIG. 1 is a block diagram that schematically shows a configuration of the fuel cell system of the first embodiment. It should be noted that FIG. 1 shows only the components necessary for describing the invention and an illustration of other components is omitted from FIG. 1.

As illustrated in FIG. 1, the fuel cell system 100 of the first embodiment of the invention has a polymer electrolyte fuel cell 1 serving as the main body of its power generation part and a temperature detector 2. When supplied with a hydrogen-containing fuel gas, an oxygen-containing oxidizing gas and a specified cooling medium, the polymer electrolyte fuel cell 1 promotes a specified electrochemical reaction by use of hydrogen contained in the fuel gas and oxygen contained in the oxidizing gas, thereby stably generating electric power and heat. The temperature detector 2 detects the temperature of the polymer electrolyte fuel cell 1. Herein, the polymer electrolyte fuel cell 1 includes, as illustrated in FIG. 1, a part of fuel gas route 1a to which the fuel gas is supplied, a part of oxidizing gas route 1b to which the oxidizing gas is supplied and a part of cooling medium route 1c to which the specified cooling medium is supplied. The polymer electrolyte fuel cell 1 further includes a part of heating medium route 1d to which the fuel gas used as a heating medium is supplied. The details of the configuration of the part of heating medium route 1d will be described later.

The fuel cell system 100 further includes a fuel gas generator 3, a pipe a, a route switching device 4, pipes b1, b2, c1, c2, a route switching device 5 and a pipe d.

The fuel gas generator 3 generates the hydrogen-rich fuel gas from a row fuel containing an organic compound composed of at least hydrogen and carbon (e.g., hydrocarbon-based raw fuel such as city gas and propane gas, and alcohol-based raw fuel such as methanol) and water. The fuel gas generator 3 supplies the generated fuel gas to the polymer electrolyte fuel cell 1. Although not shown in FIG. 1, the fuel gas generator 3 has a reformer, a shift converter and an oxidation system. The reformer generates the hydrogen-containing fuel gas through a steam reforming reaction that uses the raw fuel and water. The shift converter reduces the carbon monoxide concentration of the fuel gas generated in the reformer, by a water shift reaction that uses carbon monoxide and water. The oxidation system further reduces the carbon monoxide concentration of the fuel gas discharged from the shift converter, by an oxidation reaction that uses carbon monoxide and oxygen.

As illustrated in FIG. 1, in the fuel cell system 100, a fuel gas outlet of the fuel gas generator 3 and a fuel gas inlet of the route switching device 4 are interconnected by the pipe a. One fuel gas outlet of the route switching device 4 and a fuel gas inlet of the part of fuel gas route 1a disposed in the polymer electrolyte fuel cell 1 are interconnected by the pipe b1. The other fuel gas outlet of the route switching device 4 and a fuel gas inlet of the part of heating medium route 1d disposed in the polymer electrolyte fuel cell 1 are interconnected by the pipe b2. A fuel gas outlet of the part of fuel gas route 1a disposed in the polymer electrolyte fuel cell 1 and one fuel gas inlet of the route switching device 5 are interconnected by the pipe c1. A fuel gas outlet of the part of heating medium route 1d disposed in the polymer electrolyte fuel cell 1 and the other fuel gas inlet of the route switching device 5 are interconnected by the pipe c2. Further, a fuel gas outlet of the route switching device 5 and a combustible gas inlet of a combustor (not shown) provided in the fuel gas generator 3 are interconnected by the pipe d. Thus, a fuel gas supply-discharge system is constructed in the fuel cell system 100.

Although the first embodiment provides, as an example, the configuration in which the fuel gas outlet of the part of fuel gas route 1a and one fuel gas inlet of the route switching device 5 are interconnected by the pipe c1; the fuel gas outlet of the part of heating medium route 1d and the other fuel gas inlet of the route switching device 5 are interconnected by the pipe c2; and the fuel gas outlet of the route switching device 5 and the combustible gas inlet of the combustor of the fuel gas generator 3 are interconnected by the pipe d, it is apparent that the invention is not limited to this. An alternative example is such that a check valve is provided on the pipe c1 without use of the route switching device 5 and the fuel gas outlet of this check valve and the pipes c2, d are connected.

The fuel cell system 100 includes an oxidizing gas feeder 6, a pipe e and a pipe f.

The oxidizing gas feeder 6 actuates a blower fan such as a sirocco fan to introduce the oxidizing gas (e.g., air) into the fuel cell system 100 from outside. The oxidizing gas feeder 6 feeds the introduced oxidizing gas to the polymer electrolyte fuel cell 1. Although not shown in FIG. 1, the oxidizing gas feeder 6 is equipped with a cleaner for the oxidizing gas. In the oxidizing gas cleaner, the oxidizing gas such as air introduced into the fuel cell system 100 from outside is properly cleaned by a filter that is capable of removing dusts floating in the oxidizing gas. Although not shown in FIG. 1, the oxidizing gas feeder 6 is further equipped with a humidifier for humidifying the oxidizing gas. This humidifier humidifies the oxidizing gas introduced by the oxidizing gas feeder 6 so that the oxidizing gas has a specified dew point. The humidified oxidizing gas is fed to the polymer electrolyte fuel cell 1.

As illustrated in FIG. 1, in the fuel cell system 100, an oxidizing gas outlet of the oxidizing gas feeder 6 and an oxidizing gas inlet of the part of oxidizing gas route 1b disposed in the polymer electrolyte fuel cell 1 are interconnected by the pipe e. In addition, one end of the pipe f is connected to an oxidizing gas outlet of the part of oxidizing gas route 1b disposed in the polymer electrolyte fuel cell 1. Thus, an oxidizing gas supply-discharge system is constructed in the fuel cell system 100.

The fuel cell system 100 includes a cooling medium circulation unit 7, a pipe g and a pipe h.

The cooling medium circulation unit 7 actuates a water feeder such as a water pump to circulate the cooling medium (e.g., water) between the water feeder and the polymer electrolyte fuel cell 1. Although not shown in FIG. 1, the cooling medium circulation unit 7 has a storage tank and a cooler. The storage tank stores the cooling medium in a proper manner. The cooler properly cools the cooling medium which has risen in temperature, by means of a heat radiator capable of radiating the heat of the cooling medium to the outside of the fuel cell system 100.

As illustrated in FIG. 1, in the fuel cell system 100, a cooling medium outlet of the cooling medium circulation unit 7 and a cooling medium inlet of the part of cooling medium route 1c disposed in the polymer electrolyte fuel cell 1 are interconnected by the pipe g. In addition, a cooling medium outlet of the part of cooling medium route 1c disposed in the polymer electrolyte fuel cell 1 and a cooling medium inlet of the cooling medium circulation unit 7 are interconnected by the pipe h. Thus, a cooling medium supply-discharge system is constructed in the fuel cell system 100.

The fuel cell system 100 further includes a controller 8.

The controller 8 has a calculation unit such as microcomputers and a memory. The controller 8 controls the respective operations of the components of the fuel cell system 100, thereby properly controlling the whole operation (operational status) of the fuel cell system 100. In this specification, the controller 8 is not necessarily limited to a single controller but may be a controller group consisting of a plurality of controllers for executing specified control in cooperation. In addition, the controller 8 may be a controller group consisting of a plurality of controllers distributedly arranged to execute specified control in cooperation.

Next, the distinguishing internal configuration of the polymer electrolyte fuel cell according to the first embodiment of the invention will be described in detail with reference to the drawings.

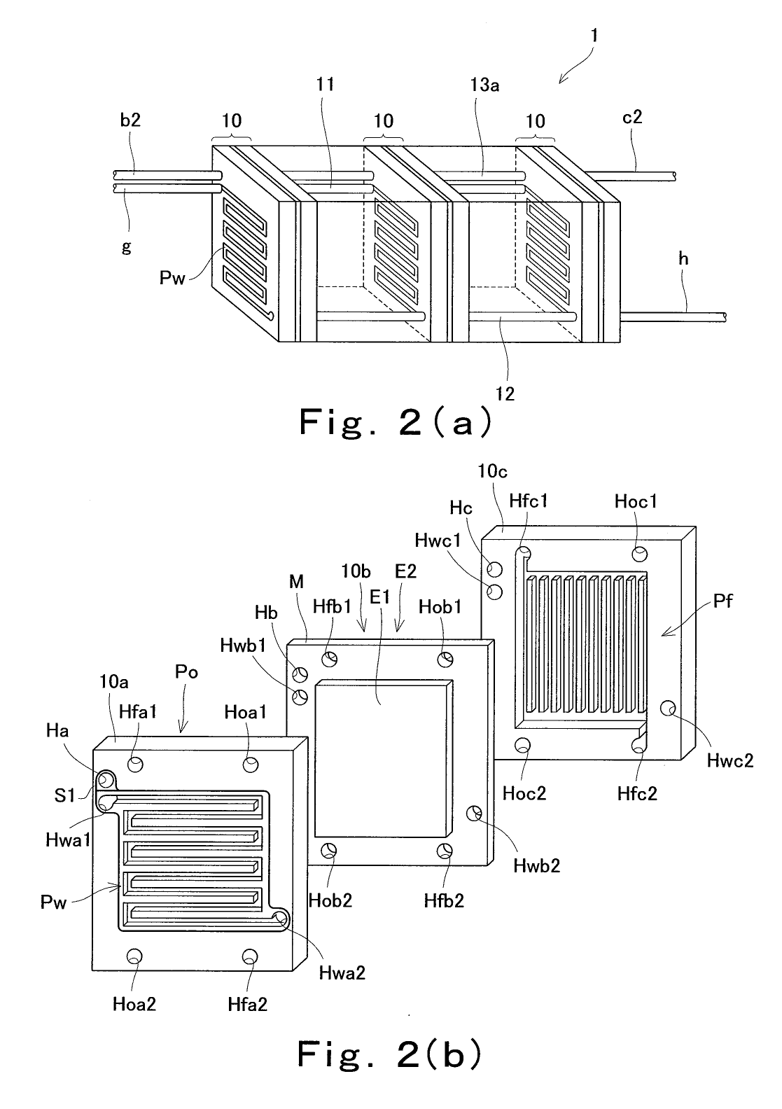

FIG. 2(a) is a perspective view that schematically shows the arrangement and configuration of a heating medium penetration passage, a cooling medium supply manifold, a cooling medium passage and a cooling medium discharge manifold in the polymer electrolyte fuel cell. It should be noted that FIG. 2(a) shows only the cells placed at both ends and the center, for easy comprehension of the arrangement and configuration of the supply and discharge manifolds, the heating medium penetration passage and the cooling medium passage. In addition, in FIG. 2(a), the polymer electrolyte fuel cell is partially perspectively shown whereas the supply and discharge manifolds, the heating medium penetration passage and the cooling medium passage are indicated by solid lines, for easy comprehension of the arrangement and configuration of the supply and discharge manifolds, the heating medium penetration passage and the cooling medium passage. Further, FIG. 2(a) shows only the components necessary for the explanation of the distinguishing internal configuration of the polymer electrolyte fuel cell according to the first embodiment of the invention and omits an illustration of other components.

As illustrated in FIG. 2(a), the polymer electrolyte fuel cell 1 of the first embodiment of the invention has cells 10. Although not shown in FIG. 2(a), several tens to several hundreds of cells are stacked and an end plate is attached to each end of the stack of cells 10 through a power collecting plate and an insulating plate, being firmly fastened with a fastener rod. In this way, the polymer electrolyte fuel cell 1 is constructed. In the polymer electrolyte fuel cell 1, cells of every adjacent pair are electrically connected to each other. Specifically, several tens to several hundreds of cells are electrically connected in series in the polymer electrolyte fuel cell 1.

As illustrated in FIG. 2(a), the polymer electrolyte fuel cell 1 has a cooling medium supply manifold 11 and a cooling medium discharge manifold 12. The cooling medium supply manifold 11 and the cooling medium discharge manifold 12 are interconnected through a serpentine-like cooling medium passage Pw provided in each cell 10 that constitutes the polymer electrolyte fuel cell 1. That is, the cooling medium supply manifold 11, the cooling medium passages Pw and the cooling medium discharge manifold 12 constitute the part of cooling medium route 1c shown in FIG. 1.

The cooling medium supply manifold 11 distributes the cooling medium supplied from the cooling medium circulation unit 7 through the pipe g to the cooling medium passages Pw of the cells 10 that constitute the polymer electrolyte fuel cell 1. On the other hand, the cooling medium discharge manifold 12 collects the cooling medium discharged from the cooling medium passages Pw of the cells 10 that constitute the polymer electrolyte fuel cell 1 and discharges the collected cooling medium to the outside of the polymer electrolyte fuel cell 1. The discharged cooling medium returns to the cooling medium circulation unit 7 by way of the pipe h.

In the first embodiment, although partially omitted in FIG. 2(a), the cooling medium supply manifold 11 is constructed in a substantially linear form in the polymer electrolyte fuel cell 1 so as to extend from the cell 10 located at one end to the cell 10 located at the other end. The cooling medium discharge manifold 12 is constructed in a substantially linear form so as to extend from the cell 10 at one end to the cell 10 at the other end in the polymer electrolyte fuel cell 1 similarly to the cooling medium supply manifold 11, although partially omitted in FIG. 2(a). As illustrated in FIG. 2(a), the cooling medium supply manifold 11 and the cooling medium discharge manifold 12 are substantially parallel with each other and located at diagonal positions in accordance with the positions of a cooling medium inlet and a cooling medium outlet of the cooling medium passage Pw of each cell 10.

As illustrated in FIG. 2(a), the polymer electrolyte fuel cell 1 has a heating medium penetration passage 13a that characterizes the invention. The heating medium penetration passage 13a corresponds to the part of heating medium route 1d shown in FIG. 1. The heating medium penetration passage 13a allows the fuel gas generated in the fuel gas generator 3 to flow, within the polymer electrolyte fuel cell 1, from the pipe b2 to the pipe c2 of the fuel cell system 100.

In this embodiment, the heating medium penetration passage 13a is constructed in a substantially linear form so as to extend from the cell 10 at one end to the cell 10 at the other end, passing through the stack of cells 10 in the polymer electrolyte fuel cell 1. The heating medium penetration passage 13a extends from the cell 10 at one end to the cell 10 at the other end, being substantially parallel with and in the vicinity of the cooling medium supply manifold 11 with a specified spacing therebetween. That is, in the first embodiment, the heating medium penetration passage 13a is provided so as to successively effectively heat the cooling medium supplied to the polymer electrolyte fuel cell 1 and the cooling medium supplied to the cooling medium supply manifold 11, using the heating medium, i.e., the fuel gas supplied from the pipe b2 as a heat source.

As illustrated in FIG. 2(a), in the fuel cell system 100 of the first embodiment, one end of the pipe g is connected to a cooling medium inlet of the cooling medium supply manifold 11 and one end of the pipe h is connected to a cooling medium outlet of the cooling medium discharge manifold 12. As illustrated in FIG. 2(a), one end of the pipe b2 is connected to a heating medium inlet of the heating medium penetration passage 13a and one end of the pipe c2 is connected to a heating medium outlet of the heating medium penetration passage 13a.

FIG. 2(b) is an exploded perspective view that schematically shows an internal configuration of each cell provided in the polymer electrolyte fuel cell.

As illustrated in FIG. 2(b), the cells 10 each have an electrically-conductive separator 10a, a membrane electrode assembly 10b and an electrically-conductive separator 10c. The electrically-conductive separator 10a, the membrane electrode assembly 10b and the electrically-conductive separator 10c are substantially in the form of a flat plate respectively. The electrically-conductive separator 10a, the membrane electrode assembly 10b and the electrically-conductive separator 10c have the same rectangular shape when viewed in the stacking direction of the polymer electrolyte fuel cell 1. In the cells 10, the electrically-conductive separator 10a, the membrane electrode assembly 10b and the electrically-conductive separator 10c are stacked in this order.

More concretely, the electrically-conductive separator 10a has the serpentine-like cooling medium passage Pw; an oxidizing gas passage Po that is provided behind the cooling medium passage Pw and therefore not seen in FIG. 2(b); manifold holes Hwa1, Hwa2; manifold holes Hoa1, Hoa2; manifold holes Hfa1, Hfa2; and a through hole Ha. In this electrically-conductive separator 10a, one end of the cooling medium passage Pw is connected to the manifold hole Hwa1 whereas the other end of the cooling medium passage Pw is connected to the manifold hole Hwa2. Although not seen in FIG. 2(b), one end of the oxidizing gas passage Po is connected to the manifold hole Hoa1 whereas the other end of the oxidizing gas passage Po is connected to the manifold hole Hoa2.

The membrane electrode assembly 10b has a polymer electrolyte membrane M; a pair of gas diffusion electrodes E1, E2; manifold holes Hwb1, Hwb2; manifold holes Hob1, Hob2; manifold holes Hfb1, Hfb2; and a through hole Hb. Herein, in this embodiment, the polymer electrolyte membrane M is a perfluorosulphonic acid film capable of selectively carrying hydrogen ions. Although not shown in FIG. 2(b), the gas diffusion electrodes E1, E2 each have an electrically-conductive catalyst layer chiefly made of platinum carbon and an electrically-conductive gas diffusion layer made of carbon fiber having electric conduction property and gas permeability. The gas diffusion electrode E1 is joined to a specified region in one main surface of the polymer electrolyte membrane M with its electrically-conductive catalyst layer being in contact with the polymer electrolyte membrane M. The gas diffusion electrode E2 is joined to a specified region in the other main surface of the polymer electrolyte membrane M with its electrically-conductive catalyst layer being in contact with the polymer electrolyte membrane M. Thus, the membrane electrode assembly 10b is constructed in each cell 10.

The electrically-conductive separator 10c has a fuel gas passage Pf; manifold holes Hwc1, Hwc2; manifold holes Hoc1, Hoc2; manifold holes Hfc1, Hfc2; and a through hole Hc. In the electrically-conductive separator 10c, one end of the fuel gas passage Pf is connected to the manifold hole Hfc1 whereas the other end of the fuel gas passage Pf is connected to the manifold hole Hfc2.

In this embodiment, the electrically-conductive separators 10a, 10c of the cells 10 are each made of an electrically-conductive material containing metal or carbon as a chief component. The periphery of the polymer electrolyte membrane M of the membrane electrode assembly 10b is sandwiched by the peripheral portions of the electrically-conductive separators 10a, 10c through a pair of gas sealing materials or gaskets (not shown), whereas specified regions of the gas diffusion electrodes E1, E2 of the membrane electrode assembly 10b are sandwiched in an electrically electrically-conductive condition by specified regions of the electrically-conductive separators 10a, 10c. In this way, each cell 10 is constructed.

In this embodiment, a part of the cooling medium supply manifold 11 is constructed by the manifold hole Hwa1, manifold hole Hwb1 and manifold hole Hwc1 of each cell 10. Since several tens to several hundreds of cells 10 are stacked, several tens to several hundreds of manifold hole assemblages each composed of the manifold holes Hwa1, Hwb1, Hwc1 are coupled so that the cooling medium supply manifold 11 shown in FIG. 2(a) is constructed. In this embodiment, a part of the cooling medium discharge manifold 12 is constructed by the manifold hole Hwa2, manifold hole Hwb2 and manifold hole Hwc2 of each cell 10. Since several tens to several hundreds of cells 10 are stacked, several tens to several hundreds of manifold hole assemblages each composed of the manifold holes Hwa2, Hwb2, Hwc2 are coupled so that the cooling medium discharge manifold 12 shown in FIG. 2(a) is constructed. In addition, the through holes Ha, Hb, Hc of each cell 10 constitute a part of the heating medium penetration passage 13a. Since several tens to several hundreds of cells 10 are stacked, several tens to several hundreds of through hole assemblages each composed of the through holes Ha, Hb, Hc are coupled so that the heating medium penetration passage 13a shown in FIG. 2(a) is constructed. That is, the fuel cell system 100 of the first embodiment has an internal manifold type polymer electrolyte fuel cell 1.

In this embodiment, the fuel gas supplied from the pipe b2 as the heating medium flows in the heating medium penetration passage 13a without coming into contact with the gas diffusion electrodes E1, E2 and is then discharged to the pipe c2.

Although not shown in FIGS. 2(a) and 2(b), one end of the pipe b1 is connected to a fuel gas inlet of a fuel gas supply manifold composed of coupled manifold hole assemblages each composed of the manifold holes Hfa1, Hfb1, Hfc1 of each cell 10. One end of the pipe c1 is connected to a fuel gas outlet of a fuel gas discharge manifold composed of coupled manifold hole assemblages each composed of the manifold holes Hfa2, Hfb2, Hfc2 of each cell 10. One end of the pipe e is connected to an oxidizing gas inlet of an oxidizing gas supply manifold composed of coupled manifold hole assemblages each composed of the manifold holes Hoa1, Hob1, Hoc1 of each cell 10. One end of the pipe f is connected to an oxidizing gas outlet of an oxidizing gas discharge manifold composed of coupled manifold hole assemblages each composed of the manifold holes Hoa2, Hob2, Hoc2 of each cell 10.

As shown in FIG. 2(b), the electrically-conductive separator 10a of each cell 10 of the first embodiment has a seal S1. The seal S1 is disposed in the electrically-conductive separator 10a so as to completely enclose all of the through hole Ha, the manifold holes Hwa1, Hwa2 and the cooling medium passage Pw, spanning the spaces between them. This seal S1 surely prevents mixing of the cooling medium flowing in the cooling medium passage Pw with the fuel gas flowing in the through hole Ha.

Next, the operation of the fuel cell system according to the first embodiment will be described in detail with reference to the drawings. Herein, an explanation of the general operation of the fuel cell system is omitted and only the distinguishing operation thereof is described.

The fuel cell system 100 of the first embodiment performs power generating operation for outputting electric power to the load by supplying the fuel gas and the oxidizing gas from the fuel gas generator 3 and the oxidizing gas feeder 6, respectively, to the polymer electrolyte fuel cell 1 and stand-by operation for shutting down the power generating operation and other operations associated therewith. In addition to the power generating operation and the stand-by operation, the fuel cell system 100 performs start-up operation for shifting the operational status of the fuel cell system 100 from the stand-by operation to the power generating operation and shut-down operation for shifting the operational status of the fuel cell system 100 from the power generating operation to the stand-by operation.

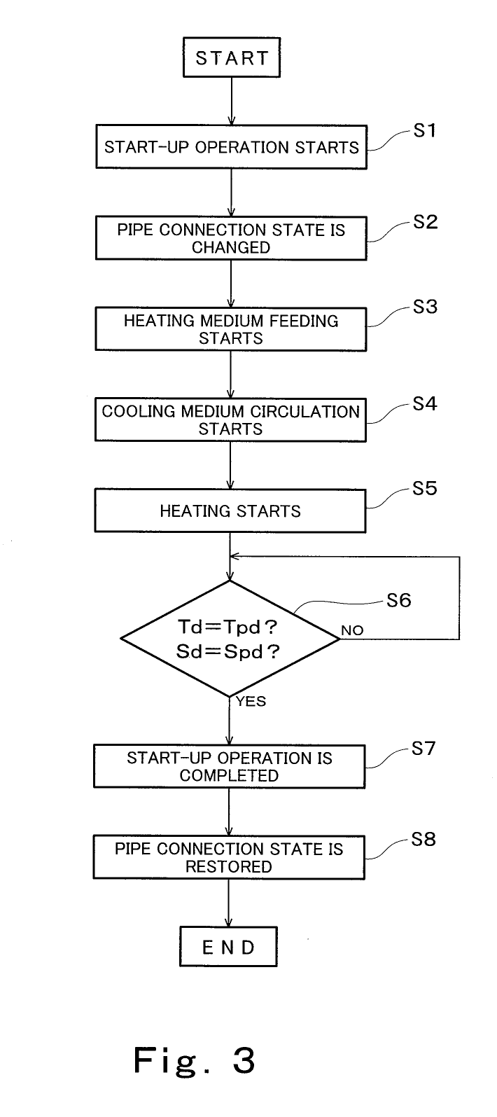

FIG. 3 is a flow chart that schematically shows the start-up operation of the fuel cell system according to the first embodiment of the invention.

As shown in FIG. 3, after starting the start-up operation of the fuel cell system 100 in response to the electric power demand of the load (Step S1), the controller 8 firstly controls the route switching device 4 and the route switching device 5, thereby interconnecting the pipe a and the pipe b2 and interconnecting the pipe c2 and the pipe d such that the fuel gas generated in the fuel gas generator 3 is fed to the part of heating medium route 1d of the polymer electrolyte fuel cell 1 (Step S2).

Next, in the fuel cell system 100, feeding of the raw fuel and other materials to the fuel gas generator 3 is started by the control of the controller 8. That is, warming-up of the fuel gas generator 3 starts. Thereby, feeding of the fuel gas generated in the fuel gas generator 3 to the part of heating medium route 1d as the heating medium starts (Step S3).

The raw fuel and water, which have been fed to the fuel gas generator 3, are supplied to the reformer of the fuel gas generator 3. The reformer of the fuel gas generator 3 generates hydrogen-containing fuel gas trough a steam reforming reaction that uses the raw fuel and water. The fuel gas generated in the reformer is fed to the shift converter of the fuel gas generator 3. The shift converter causes an aqueous shift reaction that uses carbon monoxide and water, thereby reducing the carbon monoxide concentration of the fuel gas generated in the reformer. The fuel gas, which has been reduced in carbon monoxide concentration by the shift converter, is then fed to the oxidization system of the fuel gas generator 3. The oxidation system causes an oxidation reaction that uses carbon monoxide and oxygen, thereby further reducing the carbon monoxide concentration of the fuel gas discharged from the shift converter.

In Step S3 shown in FIG. 3, the fuel gas generated in the fuel gas generator 3 is fed to the part of heating medium route 1d disposed within the polymer electrolyte fuel cell 1 by way of the pipe a, the route switching device 4 and the pipe b2. The fuel gas fed to the part of heating medium route 1d is then fed to the combustor (not shown) of the fuel gas generator 3 by way of the pipe c2, the route switching device 5 and the pipe d. The combustor combusts the combustible gas fed through the pipe d.

Simultaneously with or just after Step S3, the controller 8 performs control to start circulation of the cooling medium between the cooling medium circulation unit 7 and the part of cooling medium route 1c disposed within the polymer electrolyte fuel cell 1 (Step S4).

While starting feeding of the fuel gas from the fuel gas generator 3 to the part of heating medium route 1d disposed within the polymer electrolyte fuel cell 1, circulation of the cooling medium between the cooling medium circulation unit 7 and the part of cooling medium route 1c disposed within the polymer electrolyte fuel cell 1 is started, whereby heating of the polymer electrolyte fuel cell 1 starts in the fuel cell system 100 (Step S5).

More concretely, the hydrogen concentration of the fuel gas generated in the fuel gas generator 3 increases as the shift catalyst in the shift converter and the oxidizing catalyst in the oxidation system rise in temperature. The temperature of the fuel gas discharged from the fuel gas generator 3 gradually rises as the shift catalyst and the oxidizing catalyst rise in temperature. The fuel gas which is gradually rising in temperature is fed to the part of heating medium route 1d, that is, the fuel gas is fed to the heating medium penetration passage 13a, whereby the polymer electrolyte fuel cell 1 gradually rises in temperature, heated by the fuel gas. Herein, the fuel gas, which has been fed from the fuel gas generator 3 to the part of heating medium route 1d disposed within the polymer electrolyte fuel cell 1, finally becomes 70° C. to 100° C. in temperature and 60° C. to 70° C. in dew-point temperature. According to this embodiment, the temperature of the polymer electrolyte fuel cell 1 can be reliably raised to a specified temperature for the power generating operation, by use of the sensible heat and latent heat of the fuel gas.

As illustrated in FIG. 2(a), in this embodiment, the heating medium penetration passage 13a is disposed in the vicinity of the cooling medium supply manifold 11. Thus, the fuel gas generated in the fuel gas generator 3 is fed to the heating medium penetration passage 13a of the polymer electrolyte fuel cell 1, thereby effectively heating the cooling medium supplied to the cooling medium supply manifold 11. This causes the temperature of the cooling medium flowing in the cooling medium supply manifold 11 to effectively increase. In the polymer electrolyte fuel cell 1, the cooling medium which has been fed from the cooling medium supply manifold 11 and risen in temperature, flows in the cooling medium passages Pw of the cells 10 and is then fed to the cooling medium discharge manifold 12. The cooling medium which has risen in temperature is fed to the cooling medium passages Pw of the cells 10, so that the temperature of the polymer electrolyte fuel cell 1 can be more effectively raised.

In the fuel cell system 100, the temperature Td of the polymer electrolyte fuel cell 1 is successively detected by the temperature detector 2 and the controller 8, in and after Step S5 shown in FIG. 3. In the fuel cell system 100, the controller 8 successively makes a check to determine whether the state Sd of the fuel gas generated in the fuel gas generator 3 becomes a state Spd where the fuel gas can be supplied to the polymer electrolyte fuel cell 1, that is, whether the carbon monoxide concentration of the fuel gas has been sufficiently reduced. If it is determined that the temperature Td of the polymer electrolyte fuel cell 1 has reached a specified temperature Tpd and that the state Sd of the fuel gas generated in the fuel gas generator 3 has become the state Spd suitable for the power generating operation where the carbon monoxide concentration of the fuel gas is extremely low (YES in Step S6), the controller 8 then performs control to complete the start-up operation of the fuel cell system 100 (Step S7). If it is determined that the temperature Td of the polymer electrolyte fuel cell 1 has not reached the specified temperature Tpd and that the state Sd of the fuel gas generated in the fuel gas generator 3 has not become the state Spd suitable for the power generating operation where the carbon monoxide concentration of the fuel gas is extremely low, the controller 8 performs control to continue the start-up operation of the fuel cell system 100 (No in Step 6).

In this embodiment, the determination on whether or not the state Sd of the fuel gas has become the state Spd where the fuel gas can be supplied to the polymer electrolyte fuel cell 1 is made, for example, by determining whether the temperature of the reformer of the fuel gas generator 3 has reached a specified temperature. Alternatively, this determination may be made by determining whether the carbon monoxide concentration of the fuel gas discharged from the fuel gas generator 3 has been reduced to a specified value. It should be noted that the determination associated with the state Sd of the fuel gas may be made based on, for example, the integrated operation time of the fuel gas generator 3 or the integrated quantity of raw fuel supplied to the fuel gas generator 3.

Then, the controller 8 controls the route switching devices 4 and 5 to establish interconnection between the pipe a and the pipe b1 and between the pipe c1 and the pipe d so that the fuel gas generated by the fuel gas generator 3 is fed to the part of fuel gas route 1a disposed within the polymer electrolyte fuel cell 1 (Step S8). That is, the controller 8 performs control to restore the connection status of the pipes in the fuel cell system 100. Thereby, the fuel cell system 100 comes into a state where the fuel gas generated in the fuel gas generator 3 can be supplied to the part of fuel gas route 1a disposed in the polymer electrolyte fuel cell 1.

Upon completion of the start-up operation of the fuel cell system 100, the controller 8 performs control to start the power generating operation of the fuel cell system 100.

During the power generating operation of the fuel cell system 100, the fuel gas and the oxidizing gas are supplied from the fuel gas generator 3 and the oxidizing gas feeder 6 to the part of fuel gas route 1a and the part of oxidizing gas route 1b, respectively, which are disposed within polymer electrolyte fuel cell 1. At that time, the fuel gas generated in the fuel gas generator 3 contains an extremely low amount of carbon monoxide that is an impurity. More specifically, the fuel gas generated in the fuel gas generator 3 passes through the pipe a, the route switching device 4 and the pipe b1 and is then distributed to the fuel gas passages Pf of the cells 10 shown in FIG. 2 through the fuel gas supply manifold. Meanwhile, the oxidizing gas supplied from the oxidizing gas feeder 6 passes through the pipe e and is then distributed to the oxidizing gas passages Po of the cells 10 shown in FIG. 2 through the oxidizing gas supply manifold.

After the fuel gas has been supplied from the fuel gas generator 3 to the fuel gas passages Pf of the cells 10 while the oxidizing gas being supplied from the oxidizing gas feeder 6 to the oxidizing gas passages Po of the cells 10, an electrochemical reaction, which uses hydrogen contained in the fuel gas and oxygen contained in the oxidizing gas, proceeds in the membrane electrode assemblies 10b in the cells 10. As the electrochemical reaction progresses, the polymer electrolyte fuel cell 1 of the fuel cell system 100 generates electric power and heat at the same time. At that time, the cooling medium circulation unit 7 supplies the cooling medium to the cooling medium passages Pw of the cells 10 of the polymer electrolyte fuel cell 1 through the pipe g and the cooling medium supply manifold 11. Then, the cooling medium receives heat generated in the cells 10 and conveys the heat to the outside of the polymer electrolyte fuel cell 1. The cooling medium discharged from the cooling medium passages Pw returns to the cooling medium circulation unit 7 by way of the cooling medium discharge manifold 12 and the pipe h. Redundant fuel gas which has not been used in the electrochemical reaction is discharged from the fuel gas passages Pf of the cells 10 together with redundant steam and is then supplied to the combustor (not shown) of the fuel gas generator 3 by way of the fuel gas discharge manifold, the pipe c1, the route switching device 5 and the pipe d. Redundant oxidizing gas, which has not been used in the electrochemical reaction, is discharged from the oxidizing gas passages Po of the cells 10 together with water generated during the power generation and is then discharged to the outside of the fuel cell system 100 by way of the oxidizing gas discharge manifold and the pipe f.

In the shut-down operation of the fuel cell system 100, the controller 8 performs control to stop the feeding of the fuel gas and the oxidizing gas to the polymer electrolyte fuel cell 1. In the shut-down operation of the fuel cell system 100, for instance, the route switching device 4 and the route switching device 5 are respectively controlled by the controller 8 to thereby establish interconnection between the pipe a and the pipe b2 and between the pipe c2 and the pipe d. In the stand-by operation of the fuel cell system 100, the power generating operation of the fuel cell system 100 and all the operations associated therewith are stopped. In the fuel cell system 100 that performs the DSS operation, the start-up operation, the power generating operation, the shut-down operation and the stand-by operation are repeatedly performed in accordance with the electric power demand of the load, such that the power generating operation is not performed in time zones during which the power consumption of the load is low but performed in time zones during which the power consumption of the load is high.

According to the fuel cell system of the first embodiment, during the start-up operation, the temperature of the polymer electrolyte fuel cell can be reliably raised to a specified temperature suitable for the progress of the electrochemical reaction with good reproducibility by a simple and small-scale construction. This enables the fuel cell system to surely obtain desired electric energy from a time just after starting the power generating operation.

According to the configuration of the fuel cell system of the first embodiment, the calorie (the condensation heat of steam) obtained, for example, when lowering the temperature (70° C.) of the fuel gas having a dew point of 60° C. and a flow rate of 6 L/min. to 20° C. within 30 minutes is approximately 10 kcal. Therefore, where the heat capacity of the polymer electrolyte fuel cell is about 3 kcal, the temperature of the polymer electrolyte fuel cell can be raised by about 3° C. at a maximum. Therefore, even if the temperature of the polymer electrolyte fuel cell drops to around 17° C. during the stand-by operation, it is possible to surely raise, during the start-up operation of the fuel cell system, the temperature of the polymer electrolyte fuel cell to about 20° C. at which start-up of the fuel cell system is possible.

In the previous fuel cell systems, the fuel gas discharged from the fuel gas generator during the start-up operation is not fed to the polymer electrolyte fuel cell but fed to the combustor of the fuel gas generator. In short, the heat possessed by the fuel gas itself is not effectively utilized but substantially discarded. In contrast with this, the fuel cell system of the first embodiment makes effective use of the heat of the fuel gas itself discharged from the fuel gas generator during the start-up operation, for heating the polymer electrolyte fuel cell. This makes it possible to eliminate the need for a heating system such as a heater for heating the polymer electrolyte fuel cell and therefore reduce the amount of electric power consumed by heating, so that the fuel cell system of this embodiment can achieve higher power generation efficiency and higher total efficiency. That is, the fuel cell system of the invention provides good energy performance.

In addition, according to the fuel cell system of the first embodiment, the fuel gas discharged from the fuel gas generator is used as the heating medium and the polymer electrolyte fuel cell is directly heated by the fuel gas that serves as the heating medium. Thereby, the heating efficiency of the polymer electrolyte fuel cell is improved to a large extent, compared to the configuration in which the cooling medium is heated by the fuel gas and the polymer electrolyte fuel cell is heated by the heated cooling medium, that is, the configuration in which the polymer electrolyte fuel cell is indirectly heated by the fuel gas. Thus, the time required for the start-up operation of the fuel cell system can be reduced in this embodiment and therefore the fuel cell system of this embodiment can exhibit further improved convenience.

According to the first embodiment, the fuel cell system is provided with the heating medium penetration passage that passes through each cell of the polymer electrolyte fuel cell, which makes it possible to reduce the weight of the polymer electrolyte fuel cell. This leads to a reduction in the weight of the fuel cell system. In addition, the provision of the heating medium penetration passage passing through each cell of the polymer electrolyte fuel cell enables it to reduce the heat capacity of the polymer electrolyte fuel cell. Thus, the time required for the start-up operation of the fuel cell system can be further reduced and therefore the fuel cell system of this embodiment can exhibit further improved convenience.

In addition, according to the fuel cell system of the first embodiment, the fuel gas discharged from the fuel gas generator during the start-up operation is utilized as the heating medium for heating the polymer electrolyte fuel cell without changing its condition by catalytic combustion or the like. This enables it to simplify the configuration of the system for heating the polymer electrolyte fuel cell and, in consequence, the configuration of the fuel cell system. This contributes to a reduction in the cost of the fuel cell system.

Further, according to the fuel cell system of the first embodiment, the heating medium penetration passage of the polymer electrolyte fuel cell is sealed by the two route switching devices during the power generating operation. In this case, the sealed heating medium penetration passage functions as a heat insulating means, so that a heat retention effect and thermal insulating effect can be attained. This desirably makes the fuel cell system of this embodiment unsusceptible to environmental temperature and capable of performing stable power generating operation.

The polymer electrolyte fuel cell having the heating medium penetration passage can be easily constructed by simply providing each electrically-conductive separator and each membrane electrode assembly with a through hole that constitutes the heating medium penetration passage. Therefore, the productivity of the fuel cell system is not spoiled by carrying out the invention.

### Second Embodiment

The configuration of the fuel cell system according to the second embodiment of the invention does not differ from that of the fuel cell system 100 of the first embodiment shown in FIG. 1. Therefore, an explanation of the configuration of the fuel cell system according to the second embodiment of the invention is omitted herein.

Next, the distinguishing internal configuration of the polymer electrolyte fuel cell according to the second embodiment of the invention will be described in detail with reference to the drawings.

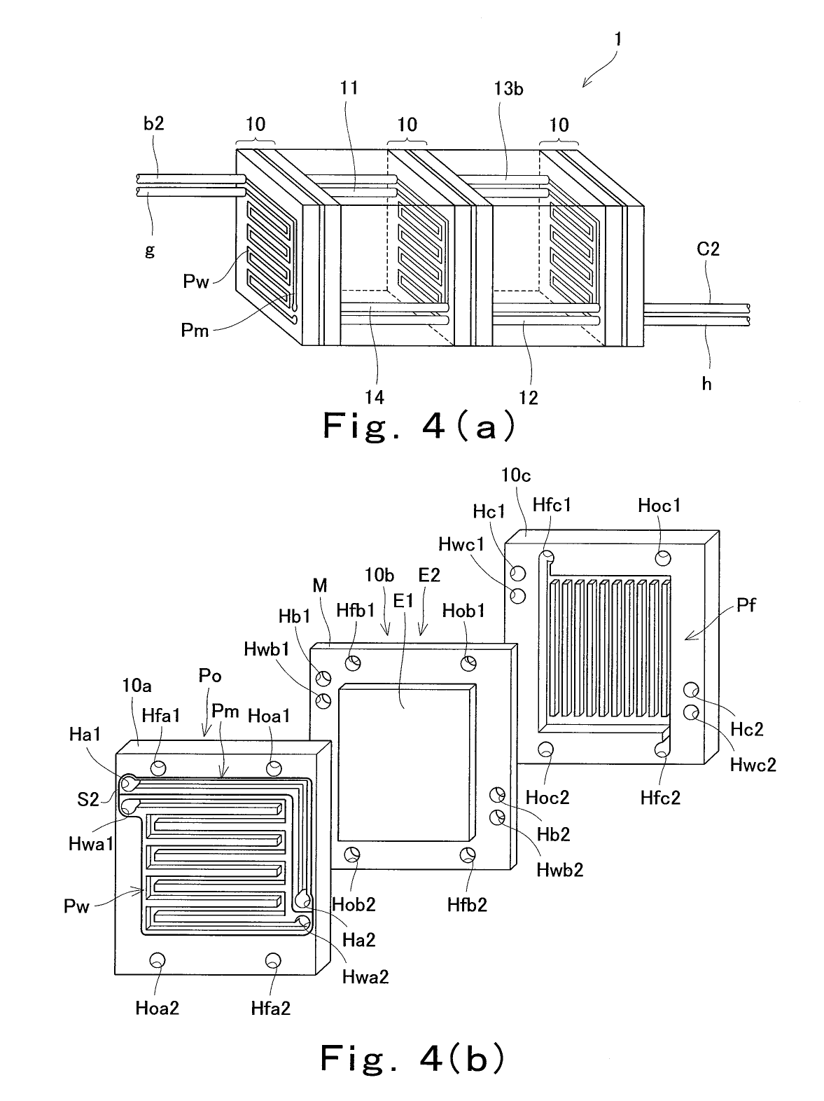

FIG. 4(a) is a perspective view that schematically shows an arrangement and configuration of a heating medium supply manifold, a cooling medium supply manifold, a heating medium passage, a cooling medium passage, a heating medium discharge manifold and a cooling medium discharge manifold in the polymer electrolyte fuel cell.

It should be noted that FIG. 4(a) shows only the cells placed at both ends and the center, for easy comprehension of the arrangement and configuration of the supply and discharge manifolds, the heating medium passage and the cooling medium passage. In addition, in FIG. 4(a), the polymer electrolyte fuel cell is partially perspectively shown whereas the supply and discharge manifolds, the heating medium passage and the cooling medium passage are indicated by solid lines, for easy comprehension of the arrangement and configuration of the supply and discharge manifolds, the heating medium passage and the cooling medium passage. Further, FIG. 4(a) shows only the components necessary for the explanation of the distinguishing internal configuration of the polymer electrolyte fuel cell according to the second embodiment of the invention and omits an illustration of other components.

FIG. 4(b) is an exploded perspective view that schematically shows the internal configuration of each cell provided in the polymer electrolyte fuel cell.

As illustrated in FIGS. 4(a), 4(b), the polymer electrolyte fuel cell 1 according to the second embodiment of the invention basically has the same configuration as of the polymer electrolyte fuel cell 1 of the first embodiment. However, the configuration of the polymer electrolyte fuel cell 1 according to the second embodiment of the invention differs from that of the polymer electrolyte fuel cell 1 of the first embodiment in that each cell 10 of the second embodiment has a heating medium passage Pm and that the second embodiment has a heating medium supply manifold 13b in place of the heating medium penetration passage 13a and further includes a heating medium discharge manifold 14. Except the above points, there is no difference between the configuration of the polymer electrolyte fuel cell 1 of the first embodiment and the configuration of the polymer electrolyte fuel cell 1 of the second embodiment.

More specifically, the polymer electrolyte fuel cell 1 of the second embodiment has the heating medium supply manifold 13b instead of the heating medium penetration passage 13a shown in FIG. 2 and further includes the heating medium passages Pm and the heating medium discharge manifold 14, as illustrated in FIG. 4(a). The heating medium supply manifold 13b and the heating medium discharge manifold 14 are interconnected through the L-shaped heating medium passage Pm provided in each cell 10 of the polymer electrolyte fuel cell 1. In short, in the polymer electrolyte fuel cell 1 of the second embodiment, the heating medium supply manifold 13b, the heating medium passages Pm and the heating medium discharge manifold 14 constitute the part of heating medium route 1d shown in FIG. 1.

In the second embodiment, the heating medium supply manifold 13b distributes the fuel gas, which has been supplied from the fuel gas generator 3 through the pipe a, the route switching device 4 and the pipe b2, to the heating medium passages Pm of the cells 10 that constitute the polymer electrolyte fuel cell 1. Then, the heating medium discharge manifold 14 recovers the fuel gas discharged from the heating medium passages Pm of the cells 10 of the polymer electrolyte fuel cell 1 and discharges it to the outside of the polymer electrolyte fuel cell 1. The discharged fuel gas is supplied to the combustor (not shown) of the fuel gas generator 3 by way of the pipe c2, the route switching device 5 and the pipe d.

In the second embodiment, the heating medium discharge manifold 14 is constructed in substantially linear form so as to extend from the cell 10 positioned at one end to the cell 10 positioned at the other end in the polymer electrolyte fuel cell 1, passing through the stack of cells 10. The heating medium discharge manifold 14 extends from the cell 10 at one end to the cell 10 at the other end, being substantially parallel with and in the vicinity of the cooling medium discharge manifold 12 with a specified spacing therebetween. As illustrated in FIG. 4(a), the heating medium supply manifold 13b and the heating medium discharge manifold 14 are substantially parallel with each other and located at diagonal positions in accordance with the positions of a heating medium inlet and a heating medium outlet of the heating medium passage Pm of each cell 10.

As illustrated in FIG. 4(a), in the fuel cell system 100 of the second embodiment, one end of the pipe b2 is connected to a heating medium inlet of the heating medium supply manifold 13b and one end of the pipe c2 is connected to a heating medium outlet of the heating medium discharge manifold 14.

As illustrated in FIG. 4(b), the electrically-conductive separator 10a of each cell 10 has the serpentine-like cooling medium passage Pw; the oxidizing gas passage Po that is provided behind the cooling medium passage Pw and therefore not seen in FIG. 4(b); the L-shaped, heating medium passage Pm located in the vicinity of the cooling medium passage Pw, the manifold holes Hwa1, Hwa2; the manifold holes How1, Hoa2; the manifold holes Hfa1, Hfa2; and manifold holes Ha1, Ha2. In this electrically-conductive separator 10a, one end of the heating medium passage Pm is connected to the manifold hole Ha1 whereas the other end of the heating medium passage Pm is connected to the manifold hole Ha2.

The membrane electrode assembly 10b has manifold holes Hb1, Hb2 in addition to the manifold holes Hwb1, Hwb2, the manifold holes Hob1, Hob2 and the manifold holes Hfb1, Hfb2. The electrically-conductive separator 10c has the fuel gas passage Pf; the manifold holes Hwc1, Hwc2; the manifold holes Hoc1, Hoc2; the manifold holes Hfc1, Hfc2; and manifold holes Hc1, Hc2.

In the second embodiment, the manifold hole Ha1, manifold hole Hb1, and manifold hole Hc1 of each cell 10 constitute a part of the heating medium supply manifold 13b. Several tens to several hundreds of cells 10 are stacked and therefore several tens to several hundreds of through hole assemblages each composed of the manifold holes Ha1, Hb1, Hc1 are coupled, whereby the heating medium supply manifold 13b shown in FIG. 4(a) is constructed. The manifold hole Ha2, manifold hole Hb2 and manifold hole Hc2 of each cell 10 constitute a part of the heating medium discharge manifold 14. Since several tens to several hundreds of cells 10 are stacked, several tens to several hundreds of through hole assemblages each composed of the manifold holes Ha2, Hb2, Hc2 are coupled, whereby the heating medium discharge manifold 14 shown in FIG. 4(a) is constructed.

As shown in FIG. 4(b), the electrically-conductive separator 10a of each cell according to the second embodiment has a seal S2. This seal S2 is disposed in the electrically-conductive separator 10a so as to enclose the manifold holes Hwa1, Hwa2, the cooling medium passage Pw, the manifold holes Ha1, Ha2 and the heating medium passage Pm, spanning the spaces between them. This seal S2 surely prevents mixing of the cooling medium flowing in the cooling medium passage Pw with the fuel gas flowing in the hating medium passage Pm. Although this seal S2 is disposed so as to enclose the manifold holes Hwa1, Hwa2, the cooling medium passage Pw, the manifold holes Ha1, Ha2 and the heating medium passage Pm, spanning the spaces between them in the second embodiment, the seal S2 is not necessarily limited to such an arrangement. For instance, the seal S2 may enclose the manifold holes Ha1, Ha2, the heating medium passage Pm, the manifold holes Hwa1, Hwa2 and the cooling medium passage Pw, separately.

Next, the operation of the fuel cell system according to the second embodiment will be described in detail with reference to the drawings.

Similarly to the first embodiment, the fuel cell system of the second embodiment is formed such that while starting feeding of the fuel gas from the fuel gas generator 3 to the part of heating medium route 1d located in the polymer electrolyte fuel cell 1, circulation of the cooling medium between the cooling medium circulation unit 7 and the part of cooling medium route 1c located in the polymer electrolyte fuel cell 1 is started, whereby heating of the polymer electrolyte fuel cell 1 starts.

Specifically, the fuel gas is fed from the fuel gas generator 3 to the heating medium passage Pm of each cell 10 through the heating medium supply manifold 13b of the polymer electrolyte fuel cell 1, so that the polymer electrolyte fuel cell 1 is heated by the fuel gas, gradually rising in temperature. In this embodiment, the heating medium supply manifold 13b is disposed in the vicinity of the cooling medium supply manifold 11 as shown in FIG. 4(a). In addition, the heating medium passage Pm is disposed in the vicinity of the cooling medium passage Pw in each cell. Therefore, the cooling medium supplied to the cooling medium supply manifold 11 as well as the cooling medium flowing in the cooling medium passages Pw is effectively heated by feeding the fuel gas generated in the fuel gas generator 3 to the heating medium supply manifold 13b and heating medium passages Pm of the polymer electrolyte fuel cell 1. This effectively raises the temperature of the cooling medium flowing in the cooling medium supply manifold 11, while effectively preventing a drop in the temperature of the cooling medium flowing in the cooling medium passages Pw. In this way, the temperature of the polymer electrolyte fuel cell 1 can be raised more rapidly and uniformly, by feeding the cooling medium, which has been raised in temperature and kept warm, to the cooling medium passages Pw of the cells 10.

After it is determined that the temperature of the polymer electrolyte fuel cell 1 has reached a specified value and the fuel gas generated in the fuel gas generator 3 has been brought into the state suitable for the power generating operation where the carbon monoxide concentration of the fuel gas is extremely low, the controller 8 performs control to complete the start-up operation of the fuel cell system. Then, the controller 8 starts the power generating operation of the fuel cell system.

According to the fuel cell system of the second embodiment, the heating medium passage of each cell can be supplied with the fuel gas, so that the time required for raising the temperature of the polymer electrolyte fuel cell can be reduced. According to the fuel cell system and its operation method of the second embodiment, the heating medium passage of each cell can be supplied with the fuel gas, so that the temperature of the polymer electrolyte fuel cell can be uniformly raised.

In addition, according to the fuel cell system of the second embodiment, each cell of the polymer electrolyte fuel cell is provided with the heating medium supply manifold, the heating medium passage and the heating medium discharge manifold, so that the weight of the polymer electrolyte fuel cell can be further reduced. This leads to a further reduction in the weight of the fuel cell system. The provision of the heating medium supply manifold, the heating medium passage and the heating medium discharge manifold in each cell of the polymer electrolyte fuel cell enables a further reduction in the heat capacity of the polymer electrolyte fuel cell. This leads to a further reduction in the time required for the start-up operation of the fuel cell system and therefore the fuel cell system of this embodiment can exhibit further improved convenience.

Further, according to the fuel cell system of the second embodiment, the heating medium supply manifold, heating medium passages and heating medium discharge manifold of the polymer electrolyte fuel cell are sealed by the two route switching devices during the power generating operation. In this case, the sealed heating medium supply manifold and heating medium passages and heating medium discharge manifold function as heat insulating means, so that a further improved heat retention effect and thermal insulating effect can be attained. This desirably makes the fuel cell system of this embodiment unsusceptible to environmental temperature and capable of performing more stable power generating operation.

The second embodiment does not differ from the first embodiment except the points described above.

### Third Embodiment

A third embodiment of the invention will be explained which is associated with a modification of the heating medium penetration passage 13a of the polymer electrolyte fuel cell 1 shown in FIG. 2(a).

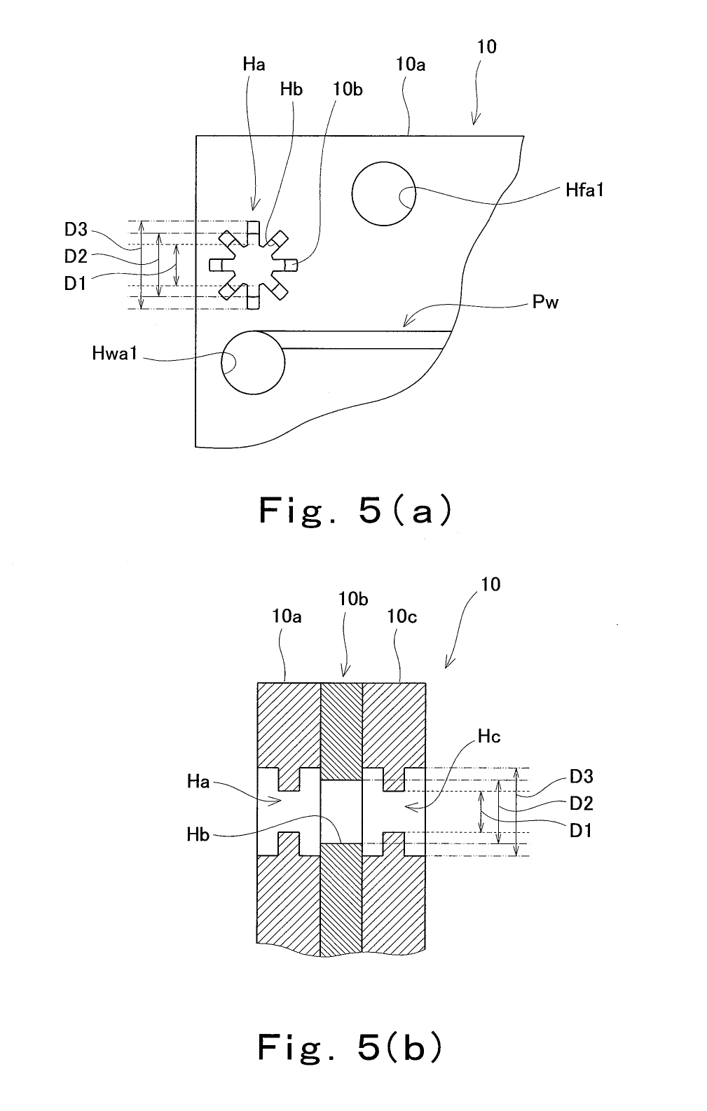

FIG. 5(a) is a front view that schematically shows a first configuration of a heating medium penetration passage provided in the polymer electrolyte fuel cell of the third embodiment of the invention. FIG. 5(b) is a sectional view that schematically shows a second configuration of the heating medium penetration passage provided in the polymer electrolyte fuel cell of the third embodiment of the invention. It should be noted that FIGS. 5(a), 5(b) each show, in enlarged form, a part of an cell taken out of the cell stack for convenience sake.

Whereas the through hole Ha of the first embodiment consists of a straight channel-like through hole having a diameter D2, the through hole Ha of the electrically-conductive separator 10a according to the first configuration of the third embodiment is composed of a straight channel-like through hole and slits as illustrated in FIG. 5(a). In the first configuration, the straight channel-like through hole has a diameter D1 (D1<D2 (D2=the diameter of the through hole Hb)) and the slits are formed around the straight channel-like through hole, radially projecting therefrom such that the through hole Ha has a diameter D3 (D3>D2). In other words, whereas the outer circumference of the through hole Ha of the first embodiment takes the form of a circle having the diameter D2, the outer circumference of the through hole Ha according to the first configuration of the third embodiment is zigzagged between the diameter D1 and the diameter D3. That is, in the first configuration, the through hole Ha is configured such that a through hole having the diameter D2 has concave parts (diameter=D1) and convex parts (diameter=D3) in a front view. Although not shown in FIG. 5(a), a plurality of cells 10 having the through holes Ha, Hc of such a shape are stacked, thereby constructing the heating medium penetration passage 13a having a distinguishing convexo-concave shape in a front view.

In the second configuration of the third embodiment, the through hole Ha of the electrically-conductive separator 10a and the through hole Hc of the electrically-conductive separator 10c are each formed as an assemblage of a first straight channel-like through hole having the diameter D1 (D1<D2 (D2=the diameter of the through hole Hb)) and second straight channel-like through holes having the diameter D3 (D3>D2) as shown in FIG. 5(b), whereas the through holes Ha, Hc of the first embodiment are a straight channel-like through hole having the diameter D2. In other words, whereas the through holes Ha, Hc of the first embodiment have the diameter D2 when viewed in the axial direction, the through holes of the second configuration of the third embodiment are zigzagged between the diameters D1 and D3. That is, in the second configuration, the through holes Ha, Hc are constructed such that a through hole of the diameter D2 has convex parts (diameter D1) and concave parts (diameter D3) in their respective sectional views. Although not shown in FIG. 5(b), the plurality of cells 10 each having the through holes Ha, Hc are stacked, thereby forming the heating medium penetration passage 13a which has a distinguishing convexo-concave shape in its sectional view.

The provision of the convex parts and concave parts in the heating medium penetration passage 13a of the polymer electrolyte fuel cell 1 leads to a significant increase in the heat exchange area of the inner wall surface of the heating medium penetration passage 13a. Thereby, the efficiency of heat transfer from the heating medium (fuel gas) flowing in the heating medium penetration passage 13a to the electrically-conductive separators 10a, 10c can be largely improved, so that the temperature of the polymer electrolyte fuel cell 1 can be raised to a specified temperature suitable for the progress of the electrochemical reaction within a short time.

In this embodiment, the shape, dimension (D1, D3) and others of the convex parts and the concave parts of the heating medium penetration passage 13a may be properly set taking account of the configuration (heat capacity) of the polymer electrolyte fuel cell 1, the flow rate of the heating medium supplied to the heating medium penetration passage 13a and the environmental temperature etc. of the installation site of the fuel cell system 100. There is no difference between the third embodiment and the first embodiment except the point described above.

### Fourth Embodiment

A fourth embodiment of the invention will be described, which is associated with a modification of the heating medium passages Pm of the polymer electrolyte fuel cell 1 shown in FIG. 4.

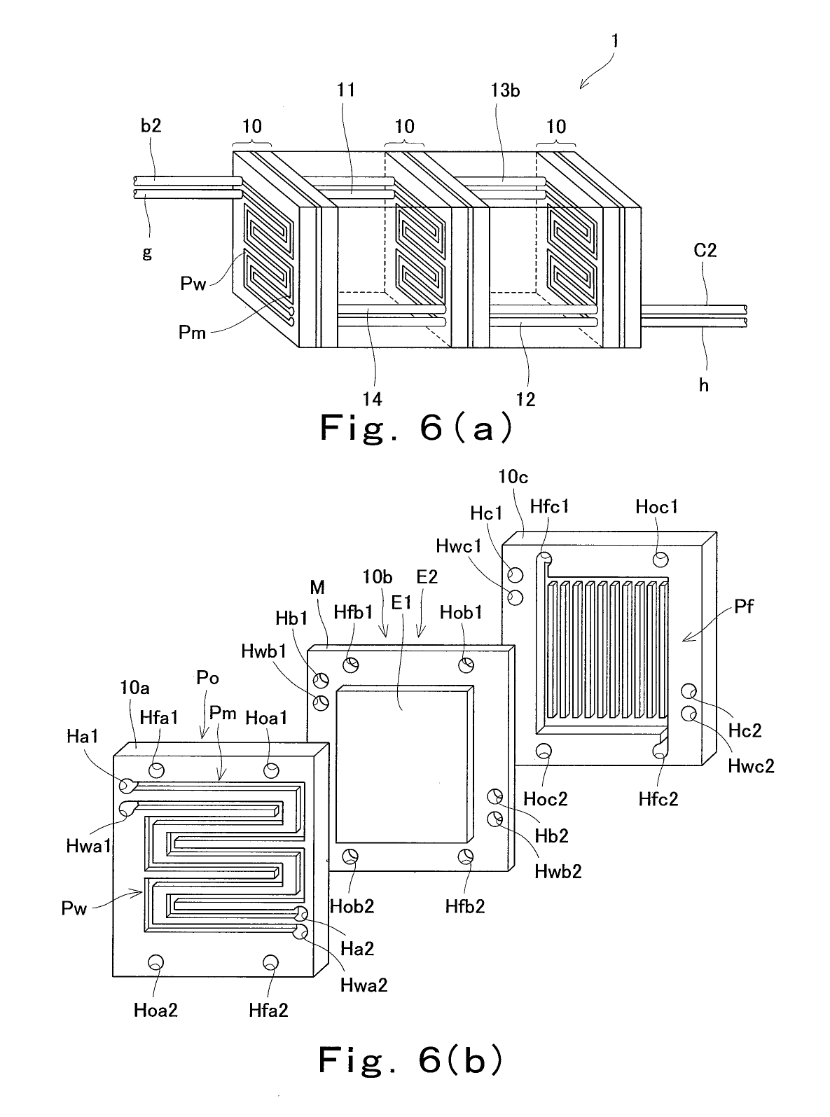

FIG. 6(a) is a perspective view that schematically shows an arrangement and configuration of a heating medium supply manifold, a cooling medium supply manifold, a heating medium passage, a cooling medium passage, a heating medium discharge manifold and a cooling medium discharge manifold in the polymer electrolyte fuel cell. FIG. 6(b) is an exploded perspective view that schematically shows an internal configuration of each cell provided in the polymer electrolyte fuel cell. It should be noted that an illustration of the seal corresponding to the seal S2 shown in FIG. 4(b) is omitted from FIG. 6(b) for convenience sake.

As illustrated in FIGS. 6(a), 6(b), the polymer electrolyte fuel cell 1 according to the fourth embodiment of the invention basically has the same configuration as of the polymer electrolyte fuel cell 1 of the second embodiment. However, the configuration of the polymer electrolyte fuel cell 1 according to the fourth embodiment of the invention differs from that of the polymer electrolyte fuel cell 1 of the second embodiment in that each cell 10 of the fourth embodiment has a serpentine-like heating medium passage Pm. Except the above point, there is no difference between the configuration of the polymer electrolyte fuel cell 1 of the fourth embodiment and the configuration of the polymer electrolyte fuel cell 1 of the second embodiment.

More specifically, the polymer electrolyte fuel cell 1 of the fourth embodiment has the heating medium supply manifold 13b, the serpentine-like heating medium passages Pm and the heating medium discharge manifold 14, as shown in FIG. 6(a). The heating medium supply manifold 13b and the heating medium discharge manifold 14 are interconnected through the serpentine-like heating medium passages Pm.

As illustrated in FIG. 6(b), the electrically-conductive separator 10a of each cell has the serpentine-like cooling medium passage Pw; the heating medium passage Pm having a serpentine shape and disposed so as to extend along the cooling medium passage Pw; the manifold holes Hwa1, Hwa2; the manifold holes Hoa1, Hoa2; the manifold holes Hfa1, Hfa2; and the manifold holes Ha1, Ha2. In the electrically-conductive separator 10a, one end of the serpentine-like heating medium passage Pm is connected to the manifold hole Ha1 whereas the other end is connected to the manifold hole Ha2. One end of the serpentine-like cooling medium passages Pw is connected to the manifold hole Hwa1 while the other end being connected to the manifold hole Hwa2.

Similarly to the second embodiment, the manifold hole Ha1, manifold hole Hb1, manifold hole Hc1 of each cell 10 constitute a part of the heating medium supply manifold 13b. A plurality of such cells 10 are stacked and therefore a plurality of through hole assemblages each composed of the manifold holes Ha1, Hb1, Hc1 are coupled, thereby forming the heating medium supply manifold 13b.

Similarly to the second embodiment, the manifold hole Ha2, manifold hole Hb2 and manifold hole Hc2 of each cell 10 constitute a part of the heating medium discharge manifold 14. Since the plurality of such cells 10 are stacked, a plurality of through hole assemblages each composed of the manifold holes Ha2, Hb2, Hc2 are coupled, thereby forming the heating medium discharge manifold 14.

The serpentine-like heating medium passage Pm is thus constructed so as to extend along the serpentine-like cooling medium passage Pw, thereby largely increasing the length of the heating medium passage Pm in each electrically-conductive separator 10a and making the heating medium passage Pm and the cooling medium passage Pw close to each other over their entire lengths. This makes it possible to further increase the efficiency of heat transfer from the heating medium (fuel gas) flowing in the heating medium passages Pm to the electrically-conductive separators 10a, 10c and the efficiency of heat transfer from the heating medium flowing in the heating medium passages Pm to the cooling medium flowing in the cooling medium passages Pw.

The fourth embodiment does not differ from the second embodiment except the point described above.

### Fifth Embodiment

A fifth embodiment of the invention will be described, which is associated with a case where each cell 10 of the polymer electrolyte fuel cell 1 has a plurality of heating medium passages Pm (two passages in this embodiment) as shown in FIG. 4.

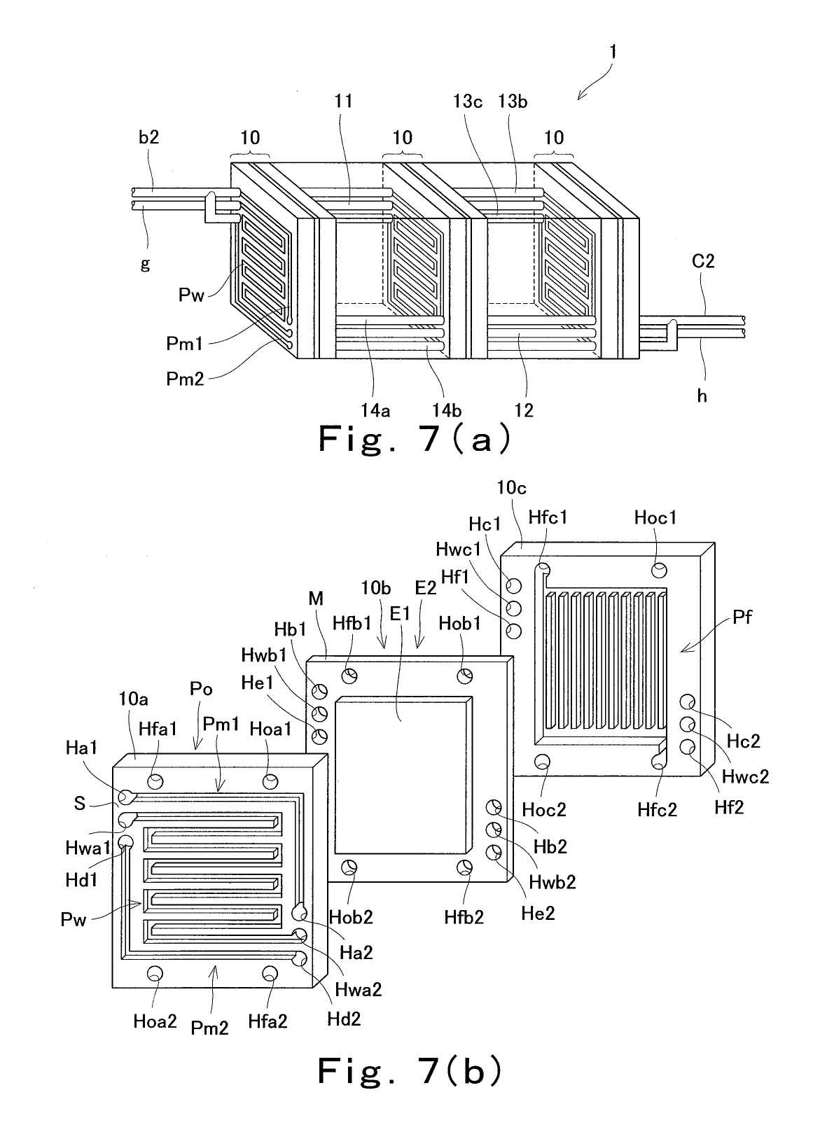

FIG. 7(a) is a perspective view that schematically shows an arrangement and configuration of heating medium supply manifolds, a cooling medium supply manifold, heating medium passages, a cooling medium passage, heating medium discharge manifolds and a cooling medium discharge manifold in the polymer electrolyte fuel cell. FIG. 7(b) is an exploded perspective view that schematically shows an internal configuration of each cell provided in the polymer electrolyte fuel cell. It should be noted that an illustration of the seal corresponding to the seal S2 shown in FIG. 4(b) is omitted from FIG. 7(b) for convenience sake.

As illustrated in FIGS. 7(a), 7(b), the polymer electrolyte fuel cell 1 according to the fifth embodiment of the invention basically has the same configuration as of the polymer electrolyte fuel cell 1 of the second embodiment. However, the configuration of the polymer electrolyte fuel cell 1 according to the fifth embodiment of the invention differs from the polymer electrolyte fuel cell 1 of the second embodiment in that each cell 10 has a pair of L-shaped heating medium passages Pm1, Pm2. Except the above point, there is no difference between the configuration of the polymer electrolyte fuel cell 1 of the fifth embodiment and the configuration of the polymer electrolyte fuel cell 1 of the second embodiment.

More concretely, the polymer electrolyte fuel cell 1 of the fifth embodiment has a pair of heating medium supply manifolds 13b, 13c and pairs of L-shaped heating medium passages Print Pm2 and a pair of heating medium discharge manifolds 14a, 14b, as illustrated in FIG. 7(a). The heating medium supply manifold 13b and the heating medium discharge manifold 14a are interconnected through the L-shaped heating medium passages Pm1. The heating medium supply manifold 13c and the heating medium discharge manifold 14b are interconnected through the L-shaped heating medium passages Pm2.

As illustrated in FIG. 7(b), the electrically-conductive separator 10a of each cell has the serpentine-like cooling medium passage Pw; the pair of heating medium passages Pm1, Pm2 each having an L-shape and disposed so as to enclose the cooling medium passage Pw in a rectangular fashion; the manifold holes Hwa1, Hwa2; the manifold holes Hoa1, Hoa2, Hfa1, Hfa2; the manifold holes Ha1, Ha2; and manifold holes Hd1, Hd2. In this electrically-conductive separator 10a, one end of the L-shaped heating medium passage Pmt is connected to the manifold hole Ha1 while the other end being connected to the manifold hole Ha2. In addition, one end of the L-shaped heating medium passage Pm2 is connected to the manifold hole Hd1 while the other end being connected to the manifold hole Hd2. Similarly to the second embodiment, one end of the serpentine-like cooling medium passage Pw is connected to the manifold hole Hwa1 whereas the other end is connected to the manifold hole Hwa2.

In the fifth embodiment, the manifold hole Ha1, manifold hole Hb1 and manifold hole Hc1 of each cell 10 constitute a part of the heating medium supply manifold 13b, similarly to the second embodiment. Meanwhile, the manifold hole Hd1, manifold hole He1 and manifold hole Hf1 of each cell 10 constitute a part of the heating medium supply manifold 13c. Since a plurality of such cells 10 are stacked, a plurality of through hole assemblages each composed of the manifold holes Ha1, Hb1, Hc1 are coupled, thereby forming the heating medium supply manifold 13b. In addition, a plurality of through hole assemblages each composed of the manifold holes Hd1, He1, Hf1 are coupled, thereby forming the heating medium supply manifold 13c.

Similarly to the second embodiment, the manifold hole Ha2, manifold hole Hb2 and manifold hole Hc2 of each cell 10 constitute a part of the heating medium discharge manifold 14a. In addition, the manifold hole Hd2, manifold hole He2 and manifold hole Hf2 of each cell 10 constitute a part of the heating medium discharge manifold 14b in this embodiment. A plurality of such cells 10 are stacked and therefore a plurality of through hole assemblages each composed of the manifold holes Ha2, Hb2, Hc2 are coupled, thereby forming the heating medium discharge manifold 14a. In addition, a plurality of through hole assemblages each composed of the manifold holes Hd2, He2, Hf2 are coupled, thereby forming the heating medium discharge manifold 14b.

As shown in FIG. 7(a), in the fifth embodiment, the pipe b2 is divided into branches at one end thereof (i.e., at the end on the side of the polymer electrolyte fuel cell 1) in order to feed the heating medium from the pipe b2 to both of the heating medium supply manifolds 13b and 13c. The pipe c2 is divided into branches at one end thereof (at the end on the side of the polymer electrolyte fuel cell 1) in order to feed the heating medium from both of the heating medium discharge manifolds 14a and 14b to the pipe c2.

The total length of the heating medium passages in the electrically-conductive separators 10a, 10c can be thus increased by providing each cell with the pair of heating medium passages Pm1, Pm2 that enclose the serpentine-like cooling medium passage Pw in a rectangular fashion. Thus, the above configuration also makes it possible to increase the efficiency of heat transfer from the heating medium flowing in the heating medium passages to the electrically-conductive separators, while increasing the efficiency of heat transfer from the heating medium flowing in the heating medium passages to the cooling medium flowing in the cooling medium passages.

The fifth embodiment does not differ from the second embodiment except the point described above.

### INDUSTRIAL APPLICABILITY

The fuel cell system according to the invention is industrially applicable as a fuel cell system that has a simple, small-scale configuration and is capable of reliably raising the temperature of the fuel cell to a specified temperature suitable for the progress of an electrochemical reaction without wasting energy during start-up operation and surely obtaining desired electric power just after starting power generating operation.

1. A fuel cell system comprising:
a fuel gas generator configured to be supplied with raw fuel, water and fuel for combustion to generate hydrogen-containing fuel gas by making use of a combustion heat of the fuel for combustion;
a fuel cell configured such that the fuel gas generated in the fuel gas generator is supplied to a fuel gas route provided in the fuel cell and oxidizing gas is supplied to an oxidizing gas route provided in the fuel cell, whereby electric power is generated;
a heating medium route configured such that the fuel gas generated in the fuel gas generator is supplied thereto instead of being supplied to the fuel gas route and at least a part of the heating medium passage passes through the fuel cell;
a route switching device configured to switch a destination of the fuel gas generated in the fuel gas generator between the fuel gas route and the heating medium route; and
a controller,
wherein the controller is configured to control the route switching device such that, during warming-up of the fuel gas generator, the fuel gas generated in the fuel gas generator is supplied to the heating medium route and then supplied to the fuel gas generator as the fuel for combustion and such that, after warming up of the fuel gas generator, the fuel gas generated in the fuel gas generator is supplied to the fuel gas route instead of being supplied to the heating medium route and then supplied to the fuel gas generator as the fuel for combustion.

2. The fuel cell system according to claim 1, further comprising:
a cooling medium route configured to allow a cooling medium to flow therein, at least a part of which passes through the fuel cell,
wherein the at least part of the cooling medium route and at least a part of the heating medium route are close to each other.

3. The fuel cell system according to claim 2,
wherein the at least part of the cooling medium route has a cooling medium supply manifold,
wherein the at least part of the heating medium route has a heating medium penetration passage, and
wherein the cooling medium supply manifold and the heating medium penetration passage are arranged in parallel.

4. The fuel cell system according to claim 3,
wherein a wall portion of the heating medium penetration passage has at least either a concave part or a convex part, and
wherein the cooling medium supply manifold and the heating medium penetration passage having at least either the concave part or the convex part are arranged in parallel.

5. The fuel cell system according to claim 3,
wherein the fuel cell includes a stack of cells each having a membrane electrode assembly composed of an electrolyte membrane and a pair of gas diffusion electrodes sandwiching the electrolyte membrane and a pair of electrically-conductive separators sandwiching the membrane electrode assembly,
wherein the cells have manifold holes configured to allow the cooling medium to pass therethrough to flow to the outside of the gas diffusion electrodes and through holes configured to allow the fuel gas to pass therethrough, and
wherein the manifold holes are coupled in a stacking direction of the cells to form the cooling medium supply manifold and the through holes are coupled in the stacking direction to form the heating medium penetration passage.

6. The fuel cell system according to claim 2,
wherein the at least part of the cooling medium route has a cooling medium supply manifold, a cooling medium passage connected to the cooling medium supply manifold and a cooling medium discharge manifold connected to the cooling medium passage, and
wherein the at least part of the heating medium route has a heating medium supply manifold, a heating medium passage connected to the heating medium supply manifold and a heating medium discharge manifold connected to the heating medium passage, and
wherein the cooling medium supply manifold and the heating medium supply manifold are arranged in parallel, the cooling medium passage and the heating medium passage are close to each other and the cooling medium discharge manifold and the heating medium discharge manifold are arranged in parallel.

7. The fuel cell system according to claim 6,
wherein the cooling medium passage and the heating medium passage have a serpentine shape, and the cooling medium passage and heating medium passage having the serpentine shape are arranged in parallel in a serpentine fashion.

8. The fuel cell system according to claim 6,
wherein the heating medium passage includes a first heating medium passage and a second heating medium passage, and
wherein the cooling medium passage is enclosed by the first and second heating medium passages.

9. The fuel cell system according to claim 6,
wherein the fuel cell is constituted by a stack of cells each having a membrane electrode assembly composed of an electrolyte membrane and a pair of gas diffusion electrodes sandwiching the electrolyte membrane and a pair of electrically-conductive separators sandwiching the membrane electrode assembly,
wherein the cells have first manifold holes configured to allow the cooling medium to pass therethrough to flow to the outside of the gas diffusion electrodes, second manifold holes configured to allow the fuel gas to pass therethrough, third manifold holes configured to allow the cooling medium to pass therethrough and fourth manifold holes configured to allow the fuel gas to pass therethrough;
wherein the first manifold holes are coupled in a stacking direction of the cells to form the cooling medium supply manifold, the second manifold holes are coupled in the stacking direction to form the heating medium supply manifold, the third manifold holes are coupled in the stacking direction to form the cooling medium discharge manifold, and the fourth manifold holes are coupled in the stacking direction to thereby form the heating medium discharge manifold.
